(19) United States
(12) Patent Application Publication
(10) Pub. No.: US 2025/0280132 A1
(43) Pub. Date: Sep. 4, 2025

(54) METHOD, APPARATUS, AND MEDIUM FOR VIDEO PROCESSING

(71) Applicants: Douyin Vision Co., Ltd., Beijing (CN); Bytedance Inc., Los Angeles, CA (US)

(72) Inventors: Zhipin DENG, Beijing (CN); Li ZHANG, Los Angeles, CA (US); Kai ZHANG, Los Angeles, CA (US); Yang WANG, Beijing (CN); Na ZHANG, Beijing (CN)

(21) Appl. No.: 19/211,020

(22) Filed: May 16, 2025

Related U.S. Application Data
(63) Continuation of application No. PCT/CN2023/131898, filed on Nov. 15, 2023.

(30) Foreign Application Priority Data
Nov. 17, 2022 (WO) PCT/CN2022/132645

(51) Int. Cl. H04N 19/176; H04N 19/159; H04N 19/186; H04N 19/59; H04N 19/70

(52) U.S. Cl. CPC H04N 19/176; H04N 19/159; H04N 19/186; H04N 19/59; H04N 19/70

(57) ABSTRACT

Embodiments of the disclosure provide a solution for video processing. A method for video processing is proposed. The method includes: determining, for a conversion between a video unit of a video and a bitstream of the video, a first block vector of a luma block of the video unit, the luma block being coded with a target coding mode; obtaining a second block vector of a chroma block of the video unit based on the first block vector of the luma block; and performing the conversion based on the first block vector of the luma block and the second block vector of the chroma block.

### CROSS REFERENCE

This application is a continuation of International Application No. PCT/CN2023/131898, filed on Nov. 15, 2023, which claims the benefit of International Application No. PCT/CN2022/132645, filed on Nov. 17, 2022. The entire contents of these applications are hereby incorporated by reference in their entireties.

### FIELDS

Embodiments of the present disclosure relates generally to video processing techniques, and more particularly, to intra prediction and screen content coding in image/video coding.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4Part 10 Advanced Video Coding (AVC), ITU-TH.265 high efficiency video coding (HEVC) standard, versatile video coding (VVC) standard, have been proposed for video encoding/decoding. However, coding efficiency of video coding techniques is generally expected to be further improved.

### SUMMARY

Embodiments of the present disclosure provide a solution for video processing.

In a first aspect, a method for video processing is proposed. The method comprises: determining, for a conversion between a video unit of a video and a bitstream of the video, a first block vector of a luma block of the video unit, the luma block being coded with a target coding mode; obtaining a second block vector of a chroma block of the video unit based on the first block vector of the luma block; and performing the conversion based on the first block vector of the luma block and the second block vector of the chroma block. In this way, the DBV mode can be improved. Further, coding efficiency is also improved.

In a second aspect, another method for video processing is proposed. The method comprises: determining, for a conversion between a video unit of a video and a bitstream of the video, a block vector associated with a neighboring block associated with the video unit, wherein the neighboring block is coded with a coding mode; applying the block vector during a current intra block coding of the video unit; and performing the conversion based on the current intra block coding. In this way, the intra luma coding can be improved. Further, coding efficiency is also improved.

In a third aspect, an apparatus for video processing is proposed. The apparatus comprises a processor and a non-transitory memory with instructions thereon. The instructions upon execution by the processor, cause the processor to perform a method in accordance with the first or second aspect of the present disclosure.

In a fourth aspect, a non-transitory computer-readable storage medium is proposed. The non-transitory computer-readable storage medium stores instructions that cause a processor to perform a method in accordance with the first or second aspect of the present disclosure.

In a fifth aspect, another non-transitory computer-readable recording medium is proposed. The non-transitory computer-readable recording medium stores a bitstream of a video which is generated by a method performed by an apparatus for video processing. The method comprises: determining a first block vector of a luma block of a video unit of the video, the luma block being coded with a target coding mode; obtaining a second block vector of a chroma block of the video unit based on the first block vector of the luma block; and generating the bitstream based on the first block vector of the luma block and the second block vector of the chroma block.

In a sixth aspect, a method for storing a bitstream of a video is proposed. The method comprises: determining a first block vector of a luma block of the video unit, the luma block being coded with a target coding mode; obtaining a second block vector of a chroma block of a video unit of the video based on the first block vector of the luma block; generating the bitstream based on the first block vector of the luma block and the second block vector of the chroma block; and storing the bitstream in a non-transitory computer-readable medium.

In a seventh aspect, another non-transitory computer-readable recording medium is proposed. The non-transitory computer-readable recording medium stores a bitstream of a video which is generated by a method performed by an apparatus for video processing. The method comprises: determining a block vector associated with a neighboring block associated with a video unit of the video, wherein the neighboring block is coded with a coding mode; applying the block vector during a current intra block coding of the video unit; and generating the bitstream based on the current intra block coding.

In an eighth aspect, a method for storing a bitstream of a video is proposed. The method comprises: determining a block vector associated with a neighboring block associated with a video unit of the video, wherein the neighboring block is coded with a coding mode; applying the block vector during a current intra block coding of the video unit; generating the bitstream based on the current intra block coding; and storing the bitstream in a non-transitory computer-readable medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 is an illustration of the effect of the slope adjustment parameter “u”, Left: model created with the current CCLM and Right: model updated as proposed;

FIG. 5 shows neighbouring blocks (L, A, BL, AR, AL) used in the derivation of a general MPM list;

FIG. 6 shows neighboring reconstructed samples used for DIMD chroma mode;

FIG. 7 shows intra template matching search area used;

FIG. 8A and FIG. 8B show the division method for angular modes;

FIG. 9 shows extended MRL candidate list;

FIG. 10 shows spatial part of the convolutional filter;

FIG. 11 shows reference area (with its paddings) used to derive the filter coefficients;

FIG. 12 shows four Sobel based gradient patterns for GLM;

FIG. 13 shows template area;

FIG. 14 shows current CTU processing order and its available reference samples in current and left CTU;

FIG. 15 shows residual coding passes for transform skip blocks;

FIG. 16 shows example of a block codded in palette mode;

FIG. 17 shows subblock-based index map scanning for palette, left for horizontal scanning and right for vertical scanning;

FIG. 18 shows decoding flowchart with ACT;

FIG. 19 shows intra template matching search area used;

FIG. 20 shows the five locations in reconstructed luma samples;

FIG. 21 shows the prediction process of DBV mode;

FIG. 22 shows an example of collocated luma block of the current chroma block in 4:2:0 color format;

FIG. 23 illustrates a flowchart of a method for video processing in accordance with embodiments of the present disclosure;

FIG. 24 illustrates a flowchart of a method for video processing in accordance with embodiments of the present disclosure; and

FIG. 25 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

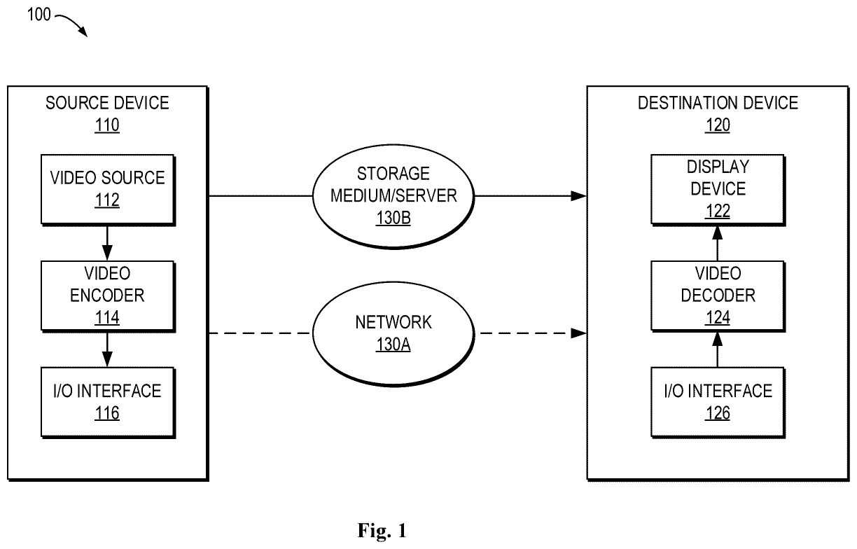

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

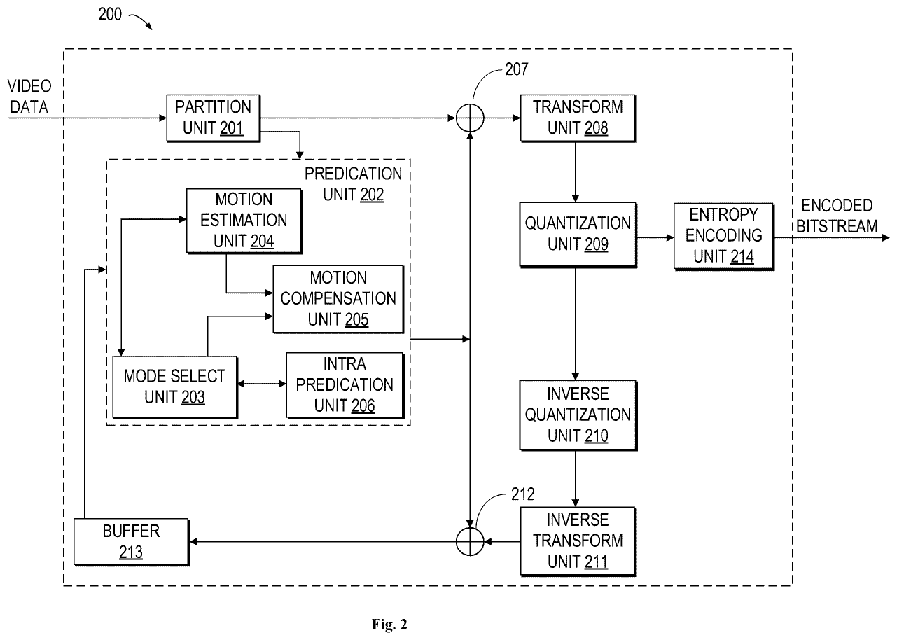

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a predication unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the predication unit 202 may include an intra block copy (IBC) unit. The IBC unit may perform predication in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter predication (CIIP) mode in which the predication is based on an inter predication signal and an intra predication signal. The mode select unit 203 may also select a resolution for a motion vector (e.g., a sub-pixel or integer pixel precision) for the block in the case of inter-predication.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector predication (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the predication unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

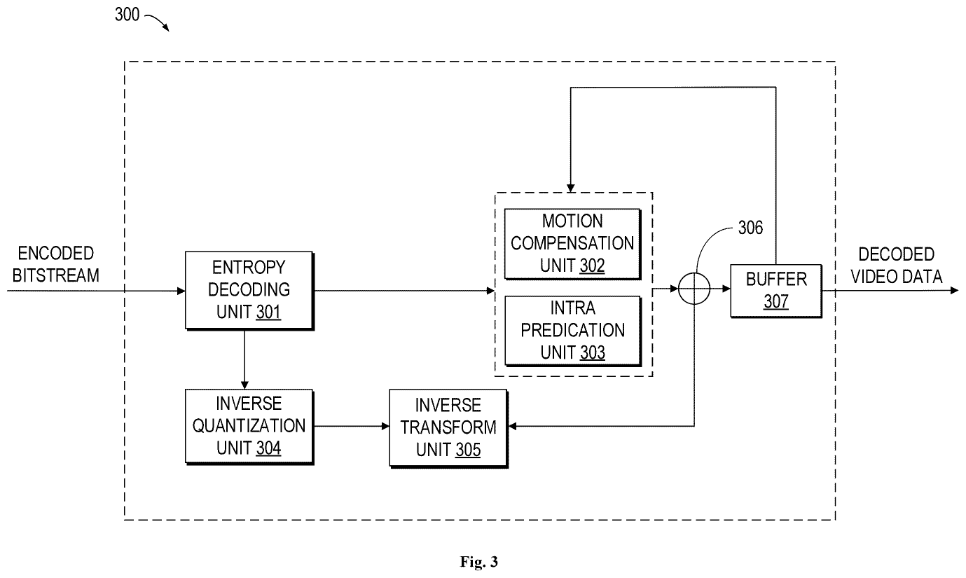

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra predication and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. Brief Summary

The present disclosure is related to video coding technologies. Specifically, it is about intra prediction and screen content coding in image/video coding. It may be applied to the existing video coding standard like HEVC, VVC, and etc. It may be also applicable to future video coding standards or video codec.

### 2. Introduction

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure wherein temporal prediction plus transform coding are utilized. To explore the future video coding technologies beyond HEVC, the Joint Video Exploration Team (JVET) was founded by VCEG and MPEG jointly in 2015. The JVET meeting is concurrently held once every quarter, and the new video coding standard was officially named as Versatile Video Coding (VVC) in the April 2018 JVET meeting, and the first version of VVC test model (VTM) was released at that time. The VVC working draft and test model VTM are then updated after every meeting. The VVC project achieved technical completion (FDIS) at the July 2020 meeting.

### 2.1 Intra Prediction

In intra prediction the smallest chroma intra prediction unit (SCIPU) constraint in VVC is removed. In addition, the VPDU constraint for reducing CCLM prediction latency is also removed.

### 2.1.1 Multi-Model LM (MMLM)

CCLM included in VVC is extended by adding three Multi-model LM (MMLM) modes (JVET-D0110). In each MMLM mode, the reconstructed neighboring samples are classified into two classes using a threshold which is the average of the luma reconstructed neighboring samples. The linear model of each class is derived using the Least-Mean-Square (LMS) method. For the CCLM mode, the LMS method is also used to derive the linear model. A slope adjustment to is applied to cross-component linear model (CCLM) and to Multi-model LM prediction. The adjustment is tilting the linear function which maps luma values to chroma values with respect to a center point determined by the average luma value of the reference samples.

### 2.1.1.1 Slope Adjustment of CCLM

CCLM uses a model with 2 parameters to map luma values to chroma values. The slope parameter “a” and the bias parameter “b” define the mapping as follows:

$$chromaVal = a * lumaVal + b .$$

An adjustment “u” to the slope parameter is signaled to update the model to the following form:

$$chromaVal = {a}^{′} * lumaVal + {b}^{′}$$

where

$${a}^{′} = a + u$$

$${b}^{′} = b - u * {y}_{r} .$$

With this selection the mapping function is tilted or rotated around the point with luminance value yᵣ. The average of the reference luma samples used in the model creation as yᵣ in order to provide a meaningful modification to the model. Picture below illustrates the process.

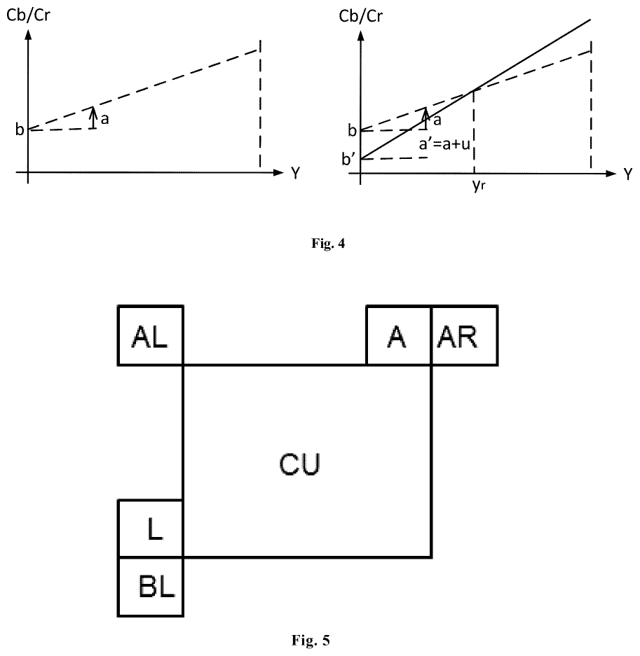

FIG. 4 is an illustration of the effect of the slope adjustment parameter “u”. Left: model created with the current CCLM. Right: model updated as proposed.

### Implementation

Slope adjustment parameter is provided as an integer between −4 and 4, inclusive, and signaled in the bitstream. The unit of the slope adjustment parameter is ⅛^{th} of a chroma sample value per one luma sample value (for 10-bit content). p Adjustment is available for the CCLM models that are using reference samples both above and left of the block (“LM_CHROMA_IDX” and “MMLM_CHROMA_IDX”), but not for the “single side” modes. This selection is based on coding efficiency vs. complexity trade-off considerations.

When slope adjustment is applied for a multimode CCLM model, both models can be adjusted and thus up to two slope updates are signaled for a single chroma block.

### Encoder Approach

The proposed encoder approach performs an SATD based search for the best value of the slope update for Cr and a similar SATD based search for Cb. If either one results as a non-zero slope adjustment parameter, the combined slope adjustment pair (SATD based update for Cr, SATD based update for Cb) is included in the list of RD checks for the TU.

### 2.1.2 Gradient PDPC

In VVC, for a few scenarios, PDPC may not be applied due to the unavailability of the secondary reference samples. In these cases, a gradient based PDPC, extended from horizontal/vertical mode, is applied (JVET-Q0391). The PDPC weights (wT/wL) and nScale parameter for determining the decay in PDPC weights with respect to the distance from left/top boundary are set equal to corresponding parameters in horizontal/vertical mode, respectively. When the secondary reference sample is at a fractional sample position, bilinear interpolation is applied.

### 2.1.3 Secondary MPM

Secondary MPM lists is introduced as described in JVET-D0114.The existing primary MPM (PMPM) list consists of 6 entries and the secondary MPM (SMPM) list includes 16 entries. A general MPM list with 22 entries is constructed first, and then the first 6 entries in this general MPM list are included into the PMPM list, and the rest of entries form the SMPM list. The first entry in the general MPM list is the Planar mode. FIG. 5 shows neighbouring blocks (L, A, BL, AR, AL) used in the derivation of a general MPM list. The remaining entries are composed of the intra modes of the left (L), above (A), below-left (BL), above-right (AR), and above-left (AL) neighbouring blocks as shown in FIG. 5, the directional modes with added offset from the first two available directional modes of neighbouring blocks, and the default modes.

If a CU block is vertically oriented, the order of neighbouring blocks is A, L, BL, AR, AL; otherwise, it is L, A, BL, AR, AL.

A PMPM flag is parsed first, if equal to 1 then a PMPM index is parsed to determine which entry of the PMPM list is selected, otherwise the SPMPM flag is parsed to determine whether to parse the SMPM index or the remaining modes.

### 2.1.4 Reference Sample Interpolation and Smoothing for Intra-Prediction

The 4-tap cubic interpolation is replaced with a 6-tap cubic interpolation filter, as described in JVET-D0119, for the derivation of predicted samples from the reference samples.

For reference sample filtering, a 6-tap gaussian filter is applied for larger blocks (W>=32 and H>=32), existing VVC 4-tap gaussian interpolation filter is applied otherwise. The extended intra reference samples are derived using the 4-tap interpolation filter instead of the nearest neighbor rounding. ps 2.1.5 Decoder Side Intra Mode Derivation (DIMD)

When DIMD is applied, two intra modes are derived from the reconstructed neighbor samples, and those two predictors are combined with the planar mode predictor with the weights derived from the gradients as described in JVET-00449. The division operations in weight derivation are performed utilizing the same lookup table (LUT) based integerization scheme used by the CCLM. For example, the division operation in the orientation calculation

$$Orient = {G}_{y} / {G}_{x}$$

is computed by the following LUT-based scheme:

x=Floor (Log2(Gx))

normDiff=((Gx<<4)>>x)& 15

x+=(3+(normDiff!=0)?1:0)

Orient=(Gy*(DivSigTable[normDiff]|8)+(1<<(x−1)))>>x

where
DivSigTable [16]={0, 7, 6, 5,5, 4, 4, 3, 3, 2, 2, 1, 1, 1, 1, 0}.

Derived intra modes are included into the primary list of intra most probable modes (MPM), so the DIMD process is performed before the MPM list is constructed. The primary derived intra mode of a DIMD block is stored with a block and is used for MPM list construction of the neighboring blocks.

### 2.1.5.1 DIMD Chroma Mode

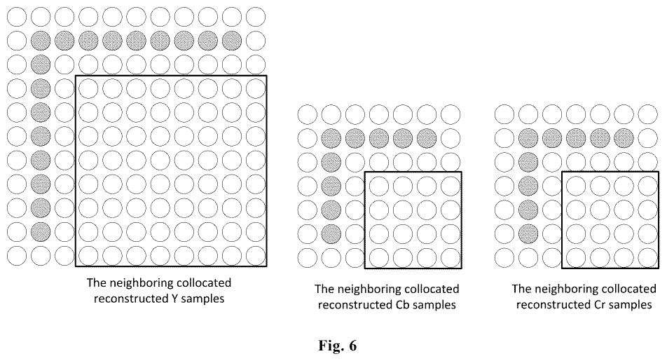

FIG. 6 shows neighboring reconstructed samples used for DIMD chroma mod. The DIMD chroma mode uses the DIMD derivation method to derive the chroma intra prediction mode of the current block based on the neighboring reconstructed Y, Cb and Cr samples in the second neighboring row and column as shown in FIG. 6. Specifically, a horizontal gradient and a vertical gradient are calculated for each collocated reconstructed luma sample of the current chroma block, as well as the reconstructed Cb and Cr samples, to build a HoG. Then the intra prediction mode with the largest histogram amplitude values is used for performing chroma intra prediction of the current chroma block.

When the intra prediction mode derived from the DIMD chroma mode is the same as the intra prediction mode derived from the DM mode, the intra prediction mode with the second largest histogram amplitude value is used as the DIMD chroma mode. A CU level flag is signaled to indicate whether the proposed DIMD chroma mode is applied.

### 2.1.6 Fusion of Chroma Intra Prediction Modes

The DM mode and the four default modes can be fused with the MMLM_LT mode as follows:

$$pred = ( w 0 * pred 0 + w 1 * pred 1 + ( 1 ≪ ( shift - 1 ) ) ) ≫ shift$$

where pred0 is the predictor obtained by applying the non-LM mode, pred1 is the predictor obtained by applying the MMLM_LT mode and pred is the final predictor of the current chroma block. The two weights, w0 and w1 are determined by the intra prediction mode of adjacent chroma blocks and shift is set equal to 2. Specifically, when the above and left adjacent blocks are both coded with LM modes, {w0, w1}={1, 3}; when the above and left adjacent blocks are both coded with non-LM modes, {w0, w1}={3, 1}; otherwise, {w0, w1}={2, 2}. For the syntax design, if a non-LM mode is selected, one flag is signaled to indicate whether the fusion is applied. This method only applies to I slices.

### 2.1.7 Intra Template Matching

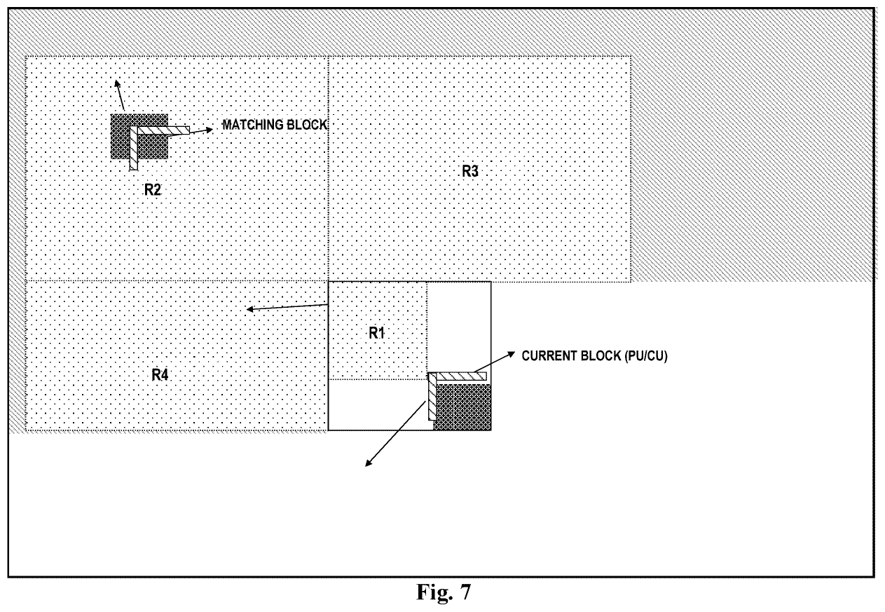

Intra template matching prediction (Intra TMP) is a special intra prediction mode that copies the best prediction block from the reconstructed part of the current frame, whose L-shaped template matches the current template. For a predefined search range, the encoder searches for the most similar template to the current template in a reconstructed part of the current frame and uses the corresponding block as a prediction block. The encoder then signals the usage of this mode, and the same prediction operation is performed at the decoder side. The prediction signal is generated by matching the L-shaped causal neighbor of the current block with another block in a predefined search area in FIG. 7 consisting of:
R1: current CTU
R2: top-left CTU
R3: above CTU
R4: left CTU.

Sum of absolute differences (SAD) is used as a cost function.

Within each region, the decoder searches for the template that has least SAD with respect to the current one and uses its corresponding block as a prediction block.

The dimensions of all regions (SearchRange_w, SearchRange_h) are set proportional to the block dimension (BlkW, BlkH) to have a fixed number of SAD comparisons per pixel. That is:

SearchRange_w=a*BlkW

SearchRange_h=a*BlkH

where ‘a’ is a constant that controls the gain/complexity trade-off. In practice, ‘a’ is equal to 5.

The Intra template matching tool is enabled for CUs with size less than or equal to 64 in width and height. This maximum CU size for Intra template matching is configurable.

The Intra template matching prediction mode is signaled at CU level through a dedicated flag when DIMD is not used for current CU.

### 2.1.8 Fusion for Template-Based Intra Mode Derivation (TIMD)

For each intra prediction mode in MPMs, The SATD between the prediction and reconstruction samples of the template is calculated. First two intra prediction modes with the minimum SATD are selected as the TIMD modes. These two TIMD modes are fused with the weights after applying PDPC process, and such weighted intra prediction is used to code the current CU. Position dependent intra prediction combination (PDPC) is included in the derivation of the TIMD modes.

The costs of the two selected modes are compared with a threshold, in the test the cost factor of 2 is applied as follows:

costMode2<2*costModel.

If this condition is true, the fusion is applied, otherwise the only model is used.

Weights of the modes are computed from their SATD costs as follows:

$$weight 1 = costMode 2 / ( costMode 1 + costMode 2 )$$

$$weight 2 = 1 - weight 1.$$

The division operations are conducted using the same lookup table (LUT) based integerization scheme used by the CCLM.

2.1.9 Combination of CIIP with TIMD and TM Merge

In CIIP mode, the prediction samples are generated by weighting an inter prediction signal predicted using CIIP-TM merge candidate and an intra prediction signal predicted using TIMD derived intra prediction mode. The method is only applied to coding blocks with an area less than or equal to 1024.

The TIMD derivation method is used to derive the intra prediction mode in CIIP. Specifically, the intra prediction mode with the smallest SATD values in the TIMD mode list is selected and mapped to one of the 67 regular intra prediction modes.

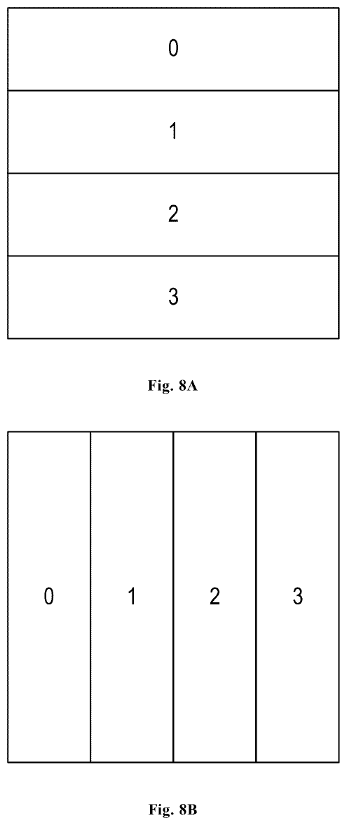

In addition, it is also proposed to modify the weights (wIntra, wInter) for the two tests if the derived intra prediction mode is an angular mode. For near-horizontal modes (2<=angular mode index<34), the current block is vertically divided as shown in FIG. 8A for near-vertical modes (34<=angular mode index<=66), the current block is horizontally divided as shown in FIG. 8B.

The (wIntra, wInter) for different sub-blocks are shown in Table 1.

TABLE 1
The modified weights used for angular modes.

| The sub-block index | (wIntra, wInter) |
|---|---|
| 0 | (6, 2) |
| 1 | (5, 3) |
| 2 | (3, 5) |
| 3 | (2, 6) |

With CIIP-TM, a CIIP-TM merge candidate list is built for the CIIP-TM mode. The merge candidates are refined by template matching. The CIIP-TM merge candidates are also reordered by the ARMC method as regular merge candidates. The maximum number of CIIP-TM merge candidates is equal to two.

### 2.1.10 Extended Multiple Reference Line (MRL) List

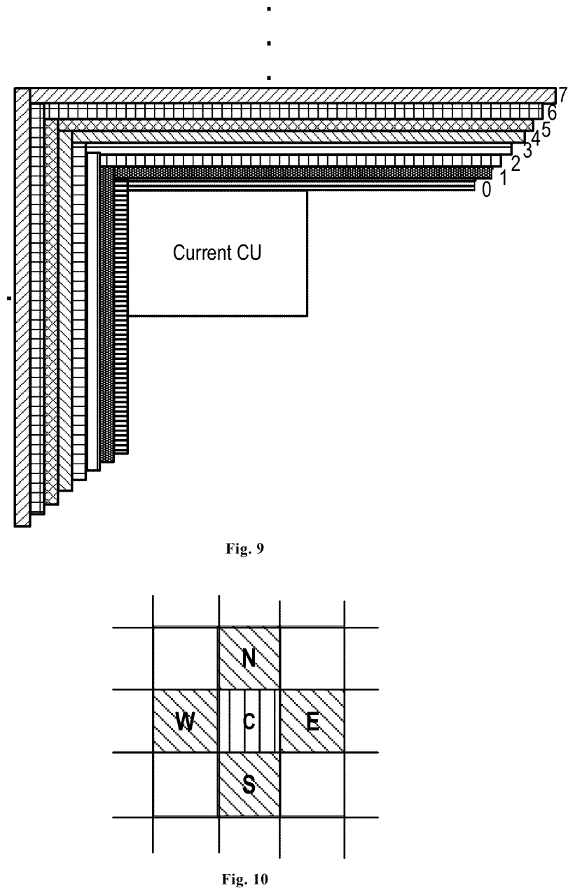

MRL list in VVC is extended to include more reference lines for intra prediction. FIG. 9 shows extended MRL candidate list. The extended reference line list consists of line indices {1, 3, 5, 7, 12} as shown FIG. 9. For template-based intra mode derivation (TIMD), instead of the full MRL candidate list, only the first two reference line candidates, i.e., {1, 3}, are used.

### 2.1.11 Convolutional Cross-Component Intra Prediction Model

In this method convolutional cross-component model (CCCM) is applied to predict chroma samples from reconstructed luma samples in a similar spirit as done by the current CCLM modes. As with CCLM, the reconstructed luma samples are down-sampled to match the lower resolution chroma grid when chroma sub-sampling is used.

Also, similarly to CCLM, there is an option of using a single model or multi-model variant of CCCM. The multi-model variant uses two models, one model derived for samples above the average luma reference value and another model for the rest of the samples (following the spirit of the CCLM design). Multi-model CCCM mode can be selected for PUs which have at least 128 reference samples available.

### 2.1.11.1 Convolutional Filter

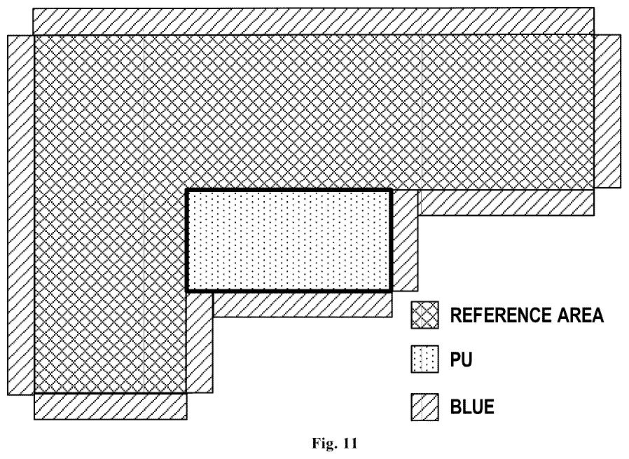

The convolutional 7-tap filter consist of a 5-tap plus sign shape spatial component, a nonlinear term and a bias term. The input to the spatial 5-tap component of the filter consists of a center (C) luma sample which is collocated with the chroma sample to be predicted and its above/north (N), below/south(S), left/west (W) and right/east (E) neighbors as illustrated below. FIG. 10 shows spatial part of the convolutional filter.

The nonlinear term P is represented as power of two of the center luma sample C and scaled to the sample value range of the content:

$$P = ( C * C + midVal ) >> bitDepth .$$

That is, for 10-bit content it is calculated as:

$$P = ( C * C + 512 ) >> 10.$$

The bias term B represents a scalar offset between the input and output (similarly to the offset term in CCLM) and is set to middle chroma value (512 for 10-bit content).

Output of the filter is calculated as a convolution between the filter coefficients ci and the input values and clipped to the range of valid chroma samples:

$$predChromaVal = {c}_{0} C + {c}_{1} N + {c}_{2} S + {c}_{3} E + {C}_{4} W + {c}_{5} P + {C}_{6} B .$$

### 2.1.11.2 Calculation of Filter Coefficients

The filter coefficients ci are calculated by minimising MSE between predicted and reconstructed chroma samples in the reference area. FIG. 11 illustrates the reference area which consists of 6 lines of chroma samples above and left of the PU. Reference area extends one PU width to the right and one PU height below the PU boundaries. Area is adjusted to include only available samples. The extensions to the area shown in blue are needed to support the “side samples” of the plus shaped spatial filter and are padded when in unavailable areas.

The MSE minimization is performed by calculating autocorrelation matrix for the luma input and a cross-correlation vector between the luma input and chroma output. Autocorrelation matrix is LDL decomposed and the final filter coefficients are calculated using back-substitution. The process follows roughly the calculation of the ALF filter coefficients in ECM, however LDL decomposition was chosen instead of Cholesky decomposition to avoid using square root operations.

### 2.1.11.3 Gradient Linear Model

Compared with the CCLM, instead of down-sampled luma values, the GLM utilizes luma sample gradients to derive the linear model. Specifically, when the GLM is applied, the input to the CCLM process, i.e., the down-sampled luma samples L, are replaced by luma sample gradients G. The other parts of the CCLM (e.g., parameter derivation, prediction sample linear transform) are kept unchanged.

$$C = α \cdot G + β$$

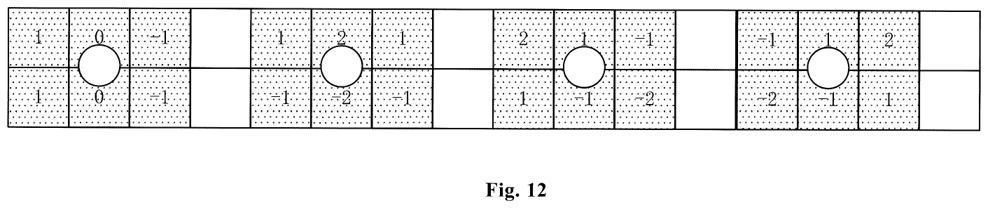

For signaling, when the CCLM mode is enabled to the current CU, two flags are signaled separately for Cb and Cr components to indicate whether GLM is enabled to each component; if the GLM is enabled for one component, one syntax element is further signaled to select one of 4 gradient filters for the gradient calculation.
Four gradient filters are enabled for the GLM, as illustrated in FIG. 12.
   2.1.11.4 Gradient Linear Model with Luma Value

In ECM-6.0, GLM utilizes the gradient of luma samples to predict a chroma sample as:

$$p r e {d}_{C} ( i , j ) = α \cdot G ( i , j ) + β ,$$

where pred_{C}(i,j) represents the predicted value of a chroma sample, G(i, j) represents the gradient of the corresponding reconstructed luma samples, and the linear model parameters α and β are derived by adjacent reconstructed samples based on the linear minimum mean square error (LMMSE) method as CCLM. In the tests, a new GLM mode is evaluated that a chroma sample is predicted based on both the gradient G(i,j) of luma samples and the reconstructed value rec′_{L}(i,j) of the down-sampled luma sample with different parameters:

$$p r e {d}_{C} ( i , j ) = {α}_{0} \cdot G ( i , j ) + {α}_{1} \cdot {rec}_{L}^{′} ( i , j ) + {α}_{2} \cdot MidValue ,$$

where the model parameters α₀, α₁ and α₂ are derived from 6 rows and columns adjacent samples based on the LDL decomposition method as the CCCM mode in ECM-6.0.

For signalling, one flag is signaled to indicate whether GLM is enabled to both Cb and Cr components, and the syntax element that indicates the gradient pattern is coded by truncated unary code.

The original GLM mode is reserved and the new GLM mode is signalled as an additional mode by signaling one extra flag in the bitstream.

### 2.1.11.5 Bitstream Signalling

Usage of the mode is signalled with a CABAC coded PU level flag. One new CABAC context was included to support this. When it comes to signalling, CCCM is considered a sub-mode of CCLM. That is, the CCCM flag is only signalled if intra prediction mode is LM_CHROMA.

### 2.1.12 Template-Based Multiple Reference Line Intra Prediction

In template-based multiple reference line intra prediction, instead of signalling the reference line and the intra mode directly, an index to the candidate list is coded to indicate which combination of the reference line and prediction mode is used for coding the current block, a truncated Golomb-Rice coding with a divisor 4 is employed to code selected combinations from the combination list.

The list of 20 candidates is constructed by combining an MPM with the reference line {1, 3, 5, 7, 12}.

The MPM list construction is modified comparing to the regular intra MPM as follows:
PLANAR mode is excluded from the intra-prediction-mode candidate list
DC mode is added after the 5 neighboring modes and DIMD modes.
The delta angles from ±1 to ±4 added to the already included to the list angular modes.

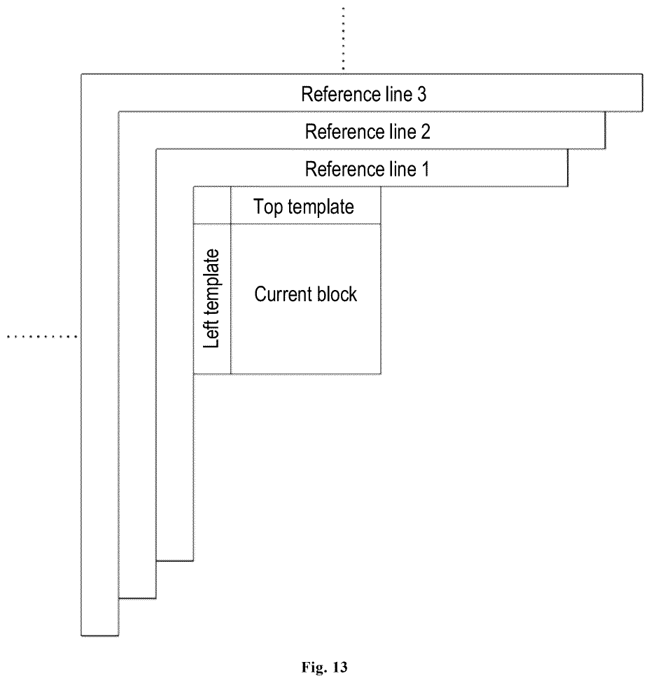

There are 5×10=50, which are sorted in the ascending order by SAD cost in the template area shown in FIG. 13. Since the extended reference line starts from reference line 1, the area covered by reference line 0 is used for the template cost calculation. The 20 combinations with the least SAD cost form the candidate list.

### 2.1.13 Intra Prediction Fusion

In this test, intra prediction is formed by fusion intra prediction derived from different reference lines as follows:
For angular intra prediction modes including the single mode case of TIMD and DIMD, the proposed method derives intra prediction by weighting intra predictions obtained from multiple reference lines represented as p_{fusion}=w₀pₗᵢₙₑ+w₁pₗᵢₙₑ₊₁, where pₗᵢₙₑ is the intra prediction from the default reference line and Pₗᵢₙₑ₊₁ is the prediction from the line above the default reference line. The weights are set as w₀=¾ and w₁=¼.
For TIMD mode with blending, pₗᵢₙₑ is used for the 1^{st} mode (w₀=1,w₁=0) and pₗᵢₙₑ₊₁ is used for the 2^{nd} mode (w₀=0, w₁=1).
For DIMD mode with blending, the number of predictors selected for a weighted average is increased from 3 to 6.

Intra prediction fusion is applied to luma blocks when angular intra mode has non-integer slope (required reference samples interpolation) and the block size is greater than 16, it is used with MRL and not applied for ISP coded blocks. PDPC is applied for the intra prediction mode using the closest to the current block reference line.

### 2.1.14 IntraTMP Adaptation for Camera-Captured Content

In the test, IntraTMP is enabled for camera-captured content with the speedup method applied, where the search area is sub-sampled by a factor of 2, which reduces the template matching search by a factor of 4. After finding the best match, a second refinement process is performed in which another template matching search is performed around the best match with a reduced search range defined as min (width, height)/2 of the current block.

### 2.2 Screen Content Coding Tools

### 2.2.1 Intra Block Copy (IBC)

Intra block copy (IBC) is a tool adopted in HEVC extensions on SCC. It is well known that it significantly improves the coding efficiency of screen content materials. Since IBC mode is implemented as a block level coding mode, block matching (BM) is performed at the encoder to find the optimal block vector (or motion vector) for each CU. Here, a block vector is used to indicate the displacement from the current block to a reference block, which is already reconstructed inside the current picture. The luma block vector of an IBC-coded CU is in integer precision. The chroma block vector rounds to integer precision as well. When combined with AMVR, the IBC mode can switch between 1-pel and 4-pel motion vector precisions. An IBC-coded CU is treated as the third prediction mode other than intra or inter prediction modes. The IBC mode is applicable to the CUs with both width and height smaller than or equal to 64 luma samples.

At the encoder side, hash-based motion estimation is performed for IBC. The encoder performs RD check for blocks with either width or height no larger than 16 luma samples. For non-merge mode, the block vector search is performed using hash-based search first. If hash search does not return valid candidate, block matching based local search will be performed.

In the hash-based search, hash key matching (32-bit CRC) between the current block and a reference block is extended to all allowed block sizes. The hash key calculation for every position in the current picture is based on 4×4 subblocks. For the current block of a larger size, a hash key is determined to match that of the reference block when all the hash keys of all 4×4 subblocks match the hash keys in the corresponding reference locations. If hash keys of multiple reference blocks are found to match that of the current block, the block vector costs of each matched reference are calculated and the one with the minimum cost is selected.

In block matching search, the search range is set to cover both the previous and current CTUs.

At CU level, IBC mode is signalled with a flag and it can be signaled as IBC AMVP mode or IBC skip/merge mode as follows:
IBC skip/merge mode: a merge candidate index is used to indicate which of the block vectors in the list from neighboring candidate IBC coded blocks is used to predict the current block. The merge list consists of spatial, HMVP, and pairwise candidates.
IBC AMVP mode: block vector difference is coded in the same way as a motion vector difference. The block vector prediction method uses two candidates as predictors, one from left neighbor and one from above neighbor (if IBC coded). When either neighbor is not available, a default block vector will be used as a predictor. A flag is signaled to indicate the block vector predictor index.

### 2.2.1.1 IBC Reference Region

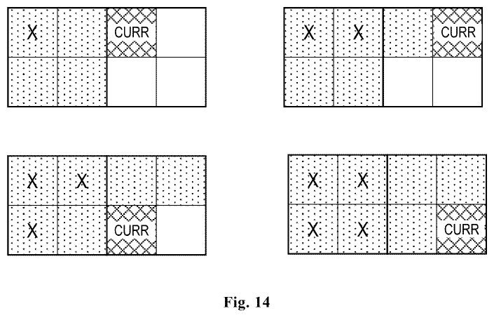

To reduce memory consumption and decoder complexity, the IBC in VVC allows only the reconstructed portion of the predefined area including the region of current CTU and some region of the left CTU. FIG. 14 illustrates the reference region of IBC Mode, where each block represents 64×64 luma sample unit.

Depending on the location of the current coding CU location within the current CTU, the following applies:
If current block falls into the top-left 64×64 block of the current CTU, then in addition to the already reconstructed samples in the current CTU, it can also refer to the reference samples in the bottom-right 64×64 blocks of the left CTU, using CPR mode. The current block can also refer to the reference samples in the bottom-left 64×64 block of the left CTU and the reference samples in the top-right 64×64 block of the left CTU, using CPR mode.
If current block falls into the top-right 64×64 block of the current CTU, then in addition to the already reconstructed samples in the current CTU, if luma location (0, 64) relative to the current CTU has not yet been reconstructed, the current block can also refer to the reference samples in the bottom-left 64×64 block and bottom-right 64×64 block of the left CTU, using CPR mode; otherwise, the current block can also refer to reference samples in bottom-right 64×64 block of the left CTU.
If current block falls into the bottom-left 64×64 block of the current CTU, then in addition to the already reconstructed samples in the current CTU, if luma location (64, 0) relative to the current CTU has not yet been reconstructed, the current block can also refer to the reference samples in the top-right 64×64 block and bottom-right 64×64 block of the left CTU, using CPR mode. Otherwise, the current block can also refer to the reference samples in the bottom-right 64×64 block of the left CTU, using CPR mode.
If current block falls into the bottom-right 64×64 block of the current CTU, it can only refer to the already reconstructed samples in the current CTU, using CPR mode.

This restriction allows the IBC mode to be implemented using local on-chip memory for hardware implementations.

### 2.2.1.2 IBC Interaction With Other Coding Tools

The interaction between IBC mode and other inter coding tools in VVC, such as pairwise merge candidate, history based motion vector predictor (HMVP), combined intra/inter prediction mode (CIIP), merge mode with motion vector difference (MMVD), and geometric partitioning mode (GPM) are as follows:
IBC can be used with pairwise merge candidate and HMVP. A new pairwise IBC merge candidate can be generated by averaging two IBC merge candidates. For HMVP, IBC motion is inserted into history buffer for future referencing.
IBC cannot be used in combination with the following inter tools: affine motion, CIIP, MMVD, and GPM.
IBC is not allowed for the chroma coding blocks when DUAL_TREE partition is used.

Unlike in the HEVC screen content coding extension, the current picture is no longer included as one of the reference pictures in the reference picture list 0 for IBC prediction. The derivation process of motion vectors for IBC mode excludes all neighboring blocks in inter mode and vice versa. The following IBC design aspects are applied:
IBC shares the same process as in regular MV merge including with pairwise merge candidate and history based motion predictor, but disallows TMVP and zero vector because they are invalid for IBC mode.
Separate HMVP buffer (5 candidates each) is used for conventional MV and IBC.
Block vector constraints are implemented in the form of bitstream conformance constraint, the encoder needs to ensure that no invalid vectors are present in the bitsream, and merge shall not be used if the merge candidate is invalid (out of range or 0). Such bitstream conformance constraint is expressed in terms of a virtual buffer as described below.
For deblocking, IBC is handled as inter mode.
If the current block is coded using IBC prediction mode, AMVR does not use quarter-pel; instead, AMVR is signaled to only indicate whether MV is inter-pel or 4 integer-pel.
The number of IBC merge candidates can be signalled in the slice header separately from the numbers of regular, subblock, and geometric merge candidates.

A virtual buffer concept is used to describe the allowable reference region for IBC prediction mode and valid block vectors. Denote CTU size as ctbSize, the virtual buffer, ibcBuf, has width being wIbcBuf=128×128/ctbSize and height hIbcBuf=ctbSize. For example, for a CTU size of 128×128, the size of ibcBuf is also 128×128; for a CTU size of 64×64, the size of ibcBuf is 256×64; and a CTU size of 32×32, the size of ibcBuf is 512×32.

The size of a VPDU is min (ctbSize, 64) in each dimension, Wᵥ=min (ctbSize, 64).

The virtual IBC buffer, ibcBuf is maintained as follows.
At the beginning of decoding each CTU row, refresh the whole ibcBuf with an invalid value −1.
At the beginning of decoding a VPDU (xVPDU, yVPDU) relative to the top-left corner of the picture, set the ibcBuf[x][y]=−1, with x=xVPDU%wIbcBuf, . . . , xVPDU%wIbcBuf+Wᵥ−1; y=yVPDU%ctbSize, . . . , yVPDU%ctbSize+Wᵥ−1.
After decoding a CU contains (x, y) relative to the top-left corner of the picture, set

ibcBuf[x%wIbcBuf][y%ctbSize]=recSample[x][y].

For a block covering the coordinates (x, y), if the following is true for a block vector bv=(bv[0], bv[1]), then it is valid; otherwise, it is not valid:

ibcBuf[(x+bv[0])%wIbcBuf][(y+bv[1])%ctbSize] shall not be equal to −1.

### 2.2.2 Block Differential Pulse Coded Modulation (BDPCM)

VVC supports block differential pulse coded modulation (BDPCM) for screen content coding. At the sequence level, a BDPCM enable flag is signalled in the SPS; this flag is signalled only if the transform skip mode (described in the next section) is enabled in the SPS.

When BDPCM is enabled, a flag is transmitted at the CU level if the CU size is smaller than or equal to Max TsSize by MaxTsSize in terms of luma samples and if the CU is intra coded, where MaxTsSize is the maximum block size for which the transform skip mode is allowed. This flag indicates whether regular intra coding or BDPCM is used. If BDPCM is used, a BDPCM prediction direction flag is transmitted to indicate whether the prediction is horizontal or vertical. Then, the block is predicted using the regular horizontal or vertical intra prediction process with unfiltered reference samples. The residual is quantized and the difference between each quantized residual and its predictor, i.e. the previously coded residual of the horizontal or vertical (depending on the BDPCM prediction direction) neighbouring position, is coded.

For a block of size M (height)×N (width), let r_{i,j}, 0≤i≤M−1, 0≤j≤N−1 be the prediction residual. Let Q(r_{i,j}), 0≤i≤M−1, 0≤j<N−1 denote the quantized version of the residual r_{i,j}. BDPCM is applied to the quantized residual values, resulting in a modified M×N array \tilde{R} with elements \tilde{r}_{i,j}, where \tilde{r}_{i,j} is predicted from its neighboring quantized residual value. For vertical BDPCM prediction mode, for 0≤j≤(N−1), the following is used to derive \tilde{r}_{i,j}:

$${\tilde{r}}_{i j} = \{ \begin{matrix}Q ( {r}_{i , j} ) , & i = 0 \\ Q ( {r}_{i , j} ) - Q ( {r}_{( i - 1 ) , j} ) , & 1 \leq i \leq ( M - 1 )\end{matrix} . \qquad ( 2 - 1 )$$

For horizontal BDPCM prediction mode, for 0≤i≤(M−1), the following is used to derive \tilde{r}_{i,j}:

$${\tilde{r}}_{i j} = \{ \begin{matrix}Q ( {r}_{i , j} ) , & j = 0 \\ Q ( {r}_{i , j} ) - Q ( {r}_{i , ( j - 1 )} ) , & 1 \leq j \leq ( N - 1 )\end{matrix} . \qquad ( 2 - 2 )$$

At the decoder side, the above process is reversed to compute Q(r_{i,j}), 0≤i≤M−1, 0≤j≤N−1, as follows:

Q(r_{i,j})=Σₖ₌₀ⁱ\tilde{r}_{k,j}, if vertical BDPCM is used (2-3)

Q(r_{i,j})=Σₖ₌₀^{j}\tilde{r}_{i,k}, if horizontal BDPCM is used (2-4).

The inverse quantized residuals, Q⁻¹ (Q(r_{i,j})), are added to the intra block prediction values to produce the reconstructed sample values.

The predicted quantized residual values \tilde{r}_{i,j} are sent to the decoder using the same residual coding process as that in transform skip mode residual coding. For lossless coding, if slice_ts_residual_coding_disabled_flag is set to 1, the quantized residual values are sent to the decoder using regular transform residual coding. In terms of the MPM mode for future intra mode coding, horizontal or vertical prediction mode is stored for a BDPCM-coded CU if the BDPCM prediction direction is horizontal or vertical, respectively. For deblocking, if both blocks on the sides of a block boundary are coded using BDPCM, then that particular block boundary is not deblocked.

### 2.2.3 Residual Coding for Transform Skip Mode

VVC allows the transform skip mode to be used for luma blocks of size up to MaxTsSize by MaxTsSize, where the value of MaxTsSize is signaled in the PPS and can be at most 32. When a CU is coded in transform skip mode, its prediction residual is quantized and coded using the transform skip residual coding process. This process is modified from the transform coefficient coding process. In transform skip mode, the residuals of a TU are also coded in units of non-overlapped subblocks of size 4×4. For better coding efficiency, some modifications are made to customize the residual coding process towards the residual signal's characteristics. The following summarizes the differences between transform skip residual coding and regular transform residual coding:
Forward scanning order is applied to scan the subblocks within a transform block and also the positions within a subblock;
no signalling of the last (x, y) position;
coded_sub_block_flag is coded for every subblock except for the last subblock when all previous flags are equal to 0;
sig_coeff_flag context modelling uses a reduced template, and context model of sig_coeff_flag depends on top and left neighbouring values;
context model of abs_level_gt1 flag also depends on the left and top sig_coeff_flag values;
par_level_flag using only one context model;
additional greater than 3, 5, 7, 9 flags are signalled to indicate the coefficient level, one context for each flag;
rice parameter derivation using fixed order=1 for the binarization of the remainder values;
context model of the sign flag is determined based on left and above neighbouring values and the sign flag is parsed after sig_coeff_flag to keep all context coded bins together.

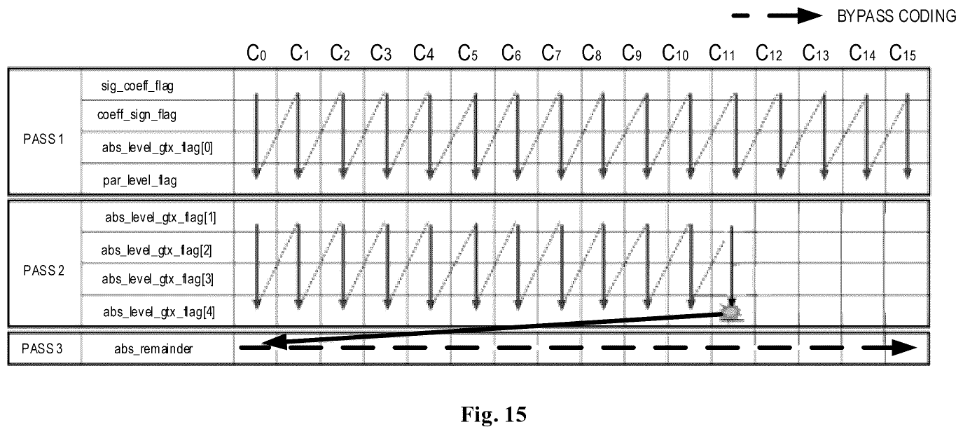

For each subblock, if the coded_subblock_flag is equal to 1 (i.e., there is at least one non-zero quantized residual in the subblock), coding of the quantized residual levels is performed in three scan passes (see FIG. 15):
First scan pass: significance flag (sig_coeff_flag), sign flag (coeff_sign_flag), absolute level greater than 1 flag (abs_level_gtx_flag[0]), and parity (par_level_flag) are coded. For a given scan position, if sig_coeff_flag is equal to 1, then coeff_sign_flag is coded, followed by the abs_level_gtx_flag[0] (which specifies whether the absolute level is greater than 1). If abs_level_gtx_flag[0] is equal to 1, then the par_level_flag is additionally coded to specify the parity of the absolute level.
Greater-than-x scan pass: for each scan position whose absolute level is greater than 1, up to four abs_level_gtx_flag[i] for i=1 . . . 4 are coded to indicate if the absolute level at the given position is greater than 3, 5, 7, or 9, respectively.
Remainder scan pass: The remainder of the absolute level abs_remainder are coded in bypass mode. The remainder of the absolute levels are binarized using a fixed rice parameter value of 1.

The bins in scan passes #1 and #2 (the first scan pass and the greater-than-x scan pass) are context coded until the maximum number of context coded bins in the TU have been exhausted. The maximum number of context coded bins in a residual block is limited to 1.75*block_width*block_height, or equivalently, 1.75 context coded bins per sample position on average. The bins in the last scan pass (the remainder scan pass) are bypass coded. A variable, RemCcbs, is first set to the maximum number of context-coded bins for the block and is decreased by one each time a context-coded bin is coded. While RemCcbs is larger than or equal to four, syntax elements in the first coding pass, which includes the sig_coeff_flag, coeff_sign_flag, abs_level_gt1_flag and par_level_flag, are coded using context-coded bins. If RemCcbs becomes smaller than 4 while coding the first pass, the remaining coefficients that have yet to be coded in the first pass are coded in the remainder scan pass (pass #3).

After completion of first pass coding, if RemCcbs is larger than or equal to four, syntax elements in the second coding pass, which includes abs_level_gt3_flag, abs_level_gt5_flag, abs_level_gt7_flag, and abs_level_gt9_flag, are coded using context coded bins. If the RemCcbs becomes smaller than 4 while coding the second pass, the remaining coefficients that have yet to be coded in the second pass are coded in the remainder scan pass (pass #3). FIG. 15 illustrates the transform skip residual coding process. The star marks the position when context coded bins are exhausted, at which point all remaining bins are coded using bypass coding.

Further, for a block not coded in the BDPCM mode, a level mapping mechanism is applied to transform skip residual coding until the maximum number of context coded bins has been reached. Level mapping uses the top and left neighbouring coefficient levels to predict the current coefficient level in order to reduce signalling cost. For a given residual position, denote absCoeff as the absolute coefficient level before mapping and absCoeffMod as the coefficient level after mapping. Let X₀ denote the absolute coefficient level of the left neighbouring position and let X₁ denote the absolute coefficient level of the above neighbouring position. The level mapping is performed as follows:

```
pred = max(X0, X1);
if (absCoeff = = pred)
      absCoeffMod = 1;
else
      absCoeffMod = (absCoeff < pred) ? absCoeff + 1 : absCoeff;
```

Then, the absCoeffMod value is coded as described above. After all context coded bins have been exhausted, level mapping is disabled for all remaining scan positions in the current block.

### 2.2.4 Palette Mode

In VVC, the palette mode is used for screen content coding in all of the chroma formats supported in a 4:4:4 profile (that is, 4:4:4, 4:2:0, 4:2:2 and monochrome). When palette mode is enabled, a flag is transmitted at the CU level if the CU size is smaller than or equal to 64×64, and the amount of samples in the CU is greater than 16 to indicate whether palette mode is used. Considering that applying palette mode on small CUs introduces insignificant coding gain and brings extra complexity on the small blocks, palette mode is disabled for CU that are smaller than or equal to 16 samples. A palette coded coding unit (CU) is treated as a prediction mode other than intra prediction, inter prediction, and intra block copy (IBC) mode.

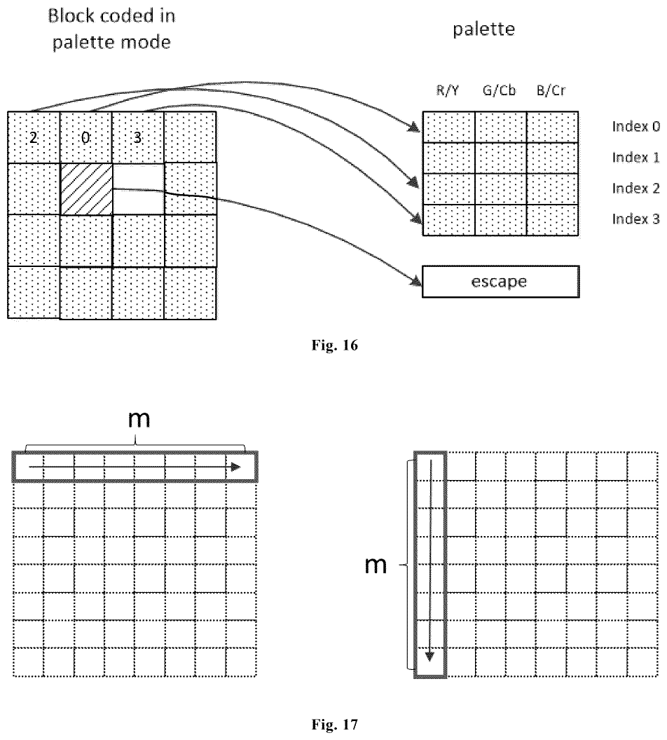

If the palette mode is utilized, the sample values in the CU are represented by a set of representative colour values. The set is referred to as the palette. For positions with sample values close to the palette colours, the palette indices are signalled. It is also possible to specify a sample that is outside the palette by signalling an escape symbol. For samples within the CU that are coded using the escape symbol, their component values are signalled directly using (possibly) quantized component values. This is illustrated in FIG. 16 which shows example of a block coded in palette mode. The quantized escape symbol is binarized with fifth order Exp-Golomb binarization process (EG5).

For coding of the palette, a palette predictor is maintained. The palette predictor is initialized to 0 at the beginning of each slice for non-wavefront case. For WPP case, the palette predictor at the beginning of each CTU row is initialized to the predictor derived from the first CTU in the previous CTU row so that the initialization scheme between palette predictors and CABAC synchronization is unified. For each entry in the palette predictor, a reuse flag is signalled to indicate whether it is part of the current palette in the CU. The reuse flags are sent using run-length coding of zeros. After this, the number of new palette entries and the component values for the new palette entries are signalled. After encoding the palette coded CU, the palette predictor will be updated using the current palette, and entries from the previous palette predictor that are not reused in the current palette will be added at the end of the new palette predictor until the maximum size allowed is reached. An escape flag is signaled for each CU to indicate if escape symbols are present in the current CU. If escape symbols are present, the palette table is augmented by one and the last index is assigned to be the escape symbol.

In a similar way as the coefficient group (CG) used in transform coefficient coding, a CU coded with palette mode is divided into multiple line-based coefficient group, each consisting of m samples (i.e., m=16), where index runs, palette index values, and quantized colors for escape mode are encoded/parsed sequentially for each CG. Same as in HEVC, horizontal or vertical traverse scan can be applied to scan the samples, as shown in FIG. 17. FIG. 17 shows subblock-based index map scanning for palette, left for horizontal scanning and right for vertical scanning.

The encoding order for palette run coding in each segment is as follows: For each sample position, 1 context coded bin run_copy_flag=0 is signalled to indicate if the pixel is of the same mode as the previous sample position, i.e., if the previously scanned sample and the current sample are both of run type COPY_ABOVE or if the previously scanned sample and the current sample are both of run type INDEX and the same index value. Otherwise, run_copy_flag=1 is signaled. If the current sample and the previous sample are of different modes, one context coded bin copy_above_palette_indices_flag is signaled to indicate the run type, i.e., INDEX or COPY_ABOVE, of the current sample. Here, decoder doesn't have to parse run type if the sample is in the first row (horizontal traverse scan) or in the first column (vertical traverse scan) since the INDEX mode is used by default. With the same way, decoder doesn't have to parse run type if the previously parsed run type is COPY_ABOVE. After palette run coding of samples in one coding pass, the index values (for INDEX mode) and quantized escape colors are grouped and coded in another coding pass using CABAC bypass coding. Such separation of context coded bins and bypass coded bins can improve the throughput within each line CG.

For slices with dual luma/chroma tree, palette is applied on luma (Y component) and chroma (Cb and Cr components) separately, with the luma palette entries containing only Y values and the chroma palette entries containing both Cb and Cr values. For slices of single tree, palette will be applied on Y, Cb, Cr components jointly, i.e., each entry in the palette contains Y, Cb, Cr values, unless when a CU is coded using local dual tree, in which case coding of luma and chroma is handled separately. In this case, if the corresponding luma or choma blocks are coded using palette mode, their palette is applied in a way similar to the dual tree case (this is related to non-4:4:4 coding and will be further explained in 0).

For slices coded with dual tree, the maximum palette predictor size is 63, and the maximum palette table size for coding of the current CU is 31. For slices coded with dual tree, the maximum predictor and palette table sizes are halved, i.e., maximum predictor size is 31 and maximum table size is 15, for each of the luma palette and the chroma palette.For deblocking, the palette coded block on the sides of a block boundary is not deblocked.

### 2.2.4.1 Palette Mode for Non-4:4:4 Content

Palette mode in VVC is supported for all chroma formats in a similar manner as the palette mode in HEVC SCC. For non-4:4:4 content, the following customization is applied:
1. When signaling the escape values for a given sample position, if that sample position has only the luma component but not the chroma component due to chroma subsampling, then only the luma escape value is signaled. This is the same as in HEVC SCC.
2. For a local dual tree block, the palette mode is applied to the block in the same way as the palette mode applied to a single tee block with two exceptions:
   a. The process of palette predictor update is slightly modified as follows. Since the local dual tree block only contains luma (or chroma) component, the predictor update process uses the signalled value of luma (or chroma) component and fills the “missing” chroma (or luma) component by setting it to a default value of (1<<(component bit depth−1)).
   b. The maximum palette predictor size is kept at 63 (since the slice is coded using single tree) but the maximum palette table size for the luma/chroma block is kept at 15 (since the block is coded using separate palette).
3. For palette mode in monochrome format, the number of colour components in a palette coded block is set to 1 instead of 3.

### 2.2.4.2 Encoder Algorithm for Palette Mode

At the encoder side, the following steps are used to produce the palette table of the current CU
1. First, to derive the initial entries in the palette table of the current CU, a simplified K-means clustering is applied. The palette table of the current CU is initialized as an empty table. For each sample position in the CU, the SAD between this sample and each palette table entry is calculated and the minimum SAD among all palette table entries is obtained. If the minimum SAD is smaller than a pre-defined error limit, errorLimit, then the current sample is clustered together with the palette table entry with the minimum SAD. Otherwise, a new palette table entry is created. The threshold errorLimit is QP-dependent and is retrieved from a look-up table containing 57 elements covering the entire QP range. After all samples of the current CU have been processed, the initial palette entries are sorted according to the number of samples clustered together with each palette entry, and any entry after the 31^{st} entry is discarded.
2. In the second step, the initial palette table colours are adjusted by considering two options: using the centroid of each cluster from step 1 or using one of the palette colours in the palette predictor. The option with lower rate-distortion cost is selected to be the final colours of the palette table. If a cluster has only a single sample and the corresponding palette entry is not in the palette predictor, the corresponding sample is converted to an escape symbol in the next step.
3. A palette table thus generated contains some new entries from the centroids of the clusters in step 1, and some entries from the palette predictor. So this table is reordered again such that all new entries (i.e. the centroids) are put at the beginning of the table, followed by entries from the palette predictor.

Given the palette table of the current CU, the encoder selects the palette index of each sample position in the CU. For each sample position, the encoder checks the RD cost of all index values corresponding to the palette table entries, as well as the index representing the escape symbol, and selects the index with the smallest RD cost using the following equation:

RD cost=distortion×(isChroma?0.8:1)+lambda×bypass coded bits (2-5).

After deciding the index map of the current CU, each entry in the palette table is checked to see if it is used by at least one sample position in the CU. Any unused palette entry will be removed.

After the index map of the current CU is decided, trellis RD optimization is applied to find the best values of run_copy_flag and run type for each sample position by comparing the RD cost of three options: same as the previously scanned position, run type COPY_ABOVE, or run type INDEX. When calculating the SAD values, sample values are scaled down to 8 bits, unless the CU is coded in lossless mode, in which case the actual input bit depth is used to calculate the SAD. Further, in the case of lossless coding, only rate is used in the rate-distortion optimization steps mentioned above (because lossless coding incurs no distortion).

### 2.2.5 Adaptive Color Transform

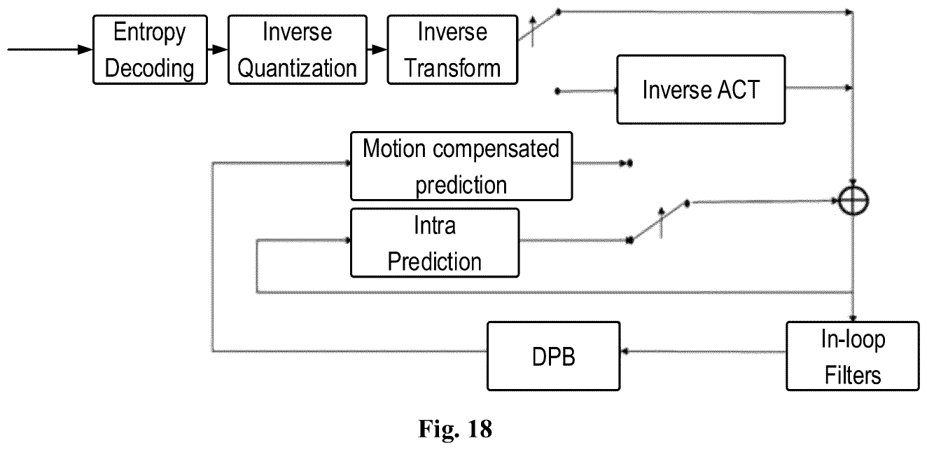

In HEVC SCC extension, adaptive color transform (ACT) was applied to reduce the redundancy between three color components in 444 chroma format. The ACT is also adopted into the VVC standard to enhance the coding efficiency of 444 chroma format coding. Same as in HEVC SCC, the ACT performs in-loop color space conversion in the prediction residual domain by adaptively converting the residuals from the input color space to YCgCo space. FIG. 18 illustrates the decoding flowchart with the ACT being applied. Two color spaces are adaptively selected by signaling one ACT flag at CU level. When the flag is equal to one, the residuals of the CU are coded in the YCgCo space; otherwise, the residuals of the CU are coded in the original color space. Additionally, same as the HEVC ACT design, for inter and IBc CUs, the ACT is only enabled when there is at least one non-zero coefficient in the CU. For intra CUs, the ACT is only enabled when chroma components select the same intra prediction mode of luma component, i.e., DM mode.

### 2.2.5.1 ACT Mode

In HEVC SCC extension, the ACT supports both lossless and lossy coding based on lossless flag (i.e.,cu_transquant_bypass_flag). However, there is no flag signalled in the bitstream to indicate whether lossy or lossless coding is applied. Therefore, YCgCo-R transform is applied as ACT to support both lossy and lossless cases. The YCgCo-R reversible colour transform is shown as below.

| Forward Conversion: | Backward Conversion: |
|---|---|
| GBR to YCgCo | YCgCo to GBR |
| Co = R − B; | t = Y − (Cg >> 1) |
| t = B + (Co >> 1); | G = Cg + t |
| Cg = G − t; | B = t − (Co >> 1) |
| Y = t + (Cg >> 1); | R = Co + B |

Since the YCgCo-R transform are not normalized. To compensate the dynamic range change of residuals signals before and after color transform, the QP adjustments of (−5, 1, 3) are applied to the transform residuals of Y, Cg and Co components, respectively. The adjusted quantization parameter only affects the quantization and inverse quantization of the residuals in the CU. For other coding processes (such as deblocking), original QP is still applied. Additionally, because the forward and inverse color transforms need to access the residuals of all three components, the ACT mode is always disabled for separate-tree partition and ISP mode where the prediction block size of different color component is different. Transform skip (TS) and block differential pulse coded modulation (BDPCM), which are extended to code chroma residuals, are also enabled when the ACT is applied.

### 2.2.5.2 ACT Fast Encoding Algorithms

To avoid brutal R-D search in both the original and converted color spaces, the following fast encoding algorithms are applied in the VTM reference software to reduce the encoder complexity when the ACT is enabled.
The order of RD checking of enabling/disabling ACT is dependent on the original color space of input video. For RGB videos, the RD cost of ACT mode is checked first; for YCbCr videos, the RD cost of non-ACT mode is checked first. The RD cost of the second color space is checked only if there is at least one non-zero coefficient in the first color space.
The same ACT enabling/disabling decision is reused when one CU is obtained through different partition path. Specifically, the selected color space for coding the residuals of one CU will be stored when the CU is coded at the first time. Then, when the same CU is obtained by another partition path, instead of checking the RD costs of the two spaces, the stored color space decision will be directly reused.
The RD cost of a parent CU is used to decide whether to check the RD cost of the second color space for the current CU. For instance, if the RD cost of the first color space is smaller than that of the second color space for the parent CU, then for the current CU, the second color space is not checked.
To reduce the number of tested coding modes, the selected coding mode is shared between two color spaces. Specifically, for intra mode, the preselected intra mode candidates based on SATD-based intra mode selection are shared between two color spaces. For inter and IBC modes, block vector search or motion estimation is performed only once. The block vectors and motion vectors are shared by two color spaces.

### 2.2.6 Intra Template Matching (IntraTMP)

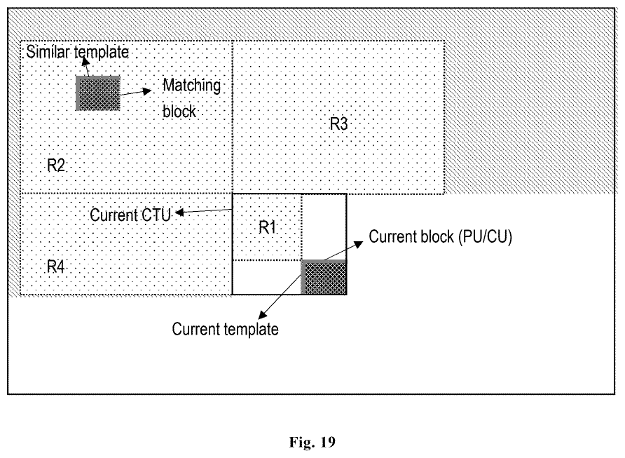

Intra template matching prediction (IntraTM) is a special intra prediction mode that copies the best prediction block from the reconstructed part of the current frame, whose L-shaped template matches the current template. For a predefined search range, the encoder searches for the most similar template to the current template in a reconstructed part of the current frame and uses the corresponding block as a prediction block. The encoder then signals the usage of this mode, and the same prediction operation is performed at the decoder side. The prediction signal is generated by matching the L-shaped causal neighbor of the current block with another block in a predefined search area in FIG. 19 consisting of:
R1: current CTU
R2: top-left CTU
R3: above CTU
R4: left CTU.

SAD is used as a cost function.

Within each region, the decoder searches for the template that has least SAD with respect to the current one and uses its corresponding block as a prediction block.

The dimensions of all regions (SearchRange_w, SearchRange_h) are set proportional to the block dimension (BlkW, BlkH) to have a fixed number of SAD comparisons per pixel. That is:

SearchRange_w=a*BlkW

SearchRange_h=a*BlkH

where ‘a’ is a constant that controls the gain/complexity trade-off. In practice, ‘a’ is equal to 5.

The Intra template matching tool is enabled for CUs with size less than or equal to 64 in width and height. This maximum CU size for Intra template matching is configurable.

The Intra template matching prediction mode is signaled at CU level through a dedicated flag when DIMD is not used for current CU.

### 2.2.7 Using Block Vector Derived From IntraTMP for IBC

Block vector (BV) derived from the intra template matching prediction (IntraTMP) is used for intra block copy (IBC). The stored IntraTMP BV of the neighboring blocks along with IBC BV are used as spatial BV candidates in IBC candidate list construction.

### 2.2.8 Direct Block Vector (DBV) Mode for Chroma Prediction

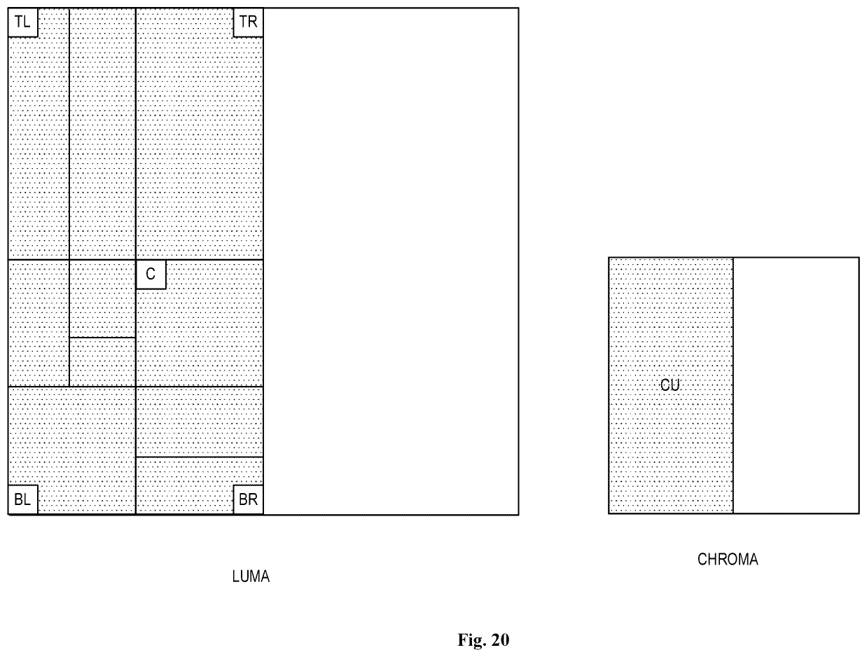

For chroma components, when chroma dual tree is activated in intra slice, if one of the luma blocks (the five locations) is coded with MODE_IBC, its block vector bvL is used and scaled to derive chroma block vector bvC. The scaling factor depends on the chroma format sampling structure. FIG. 20 shows the five locations in reconstructed luma samples.

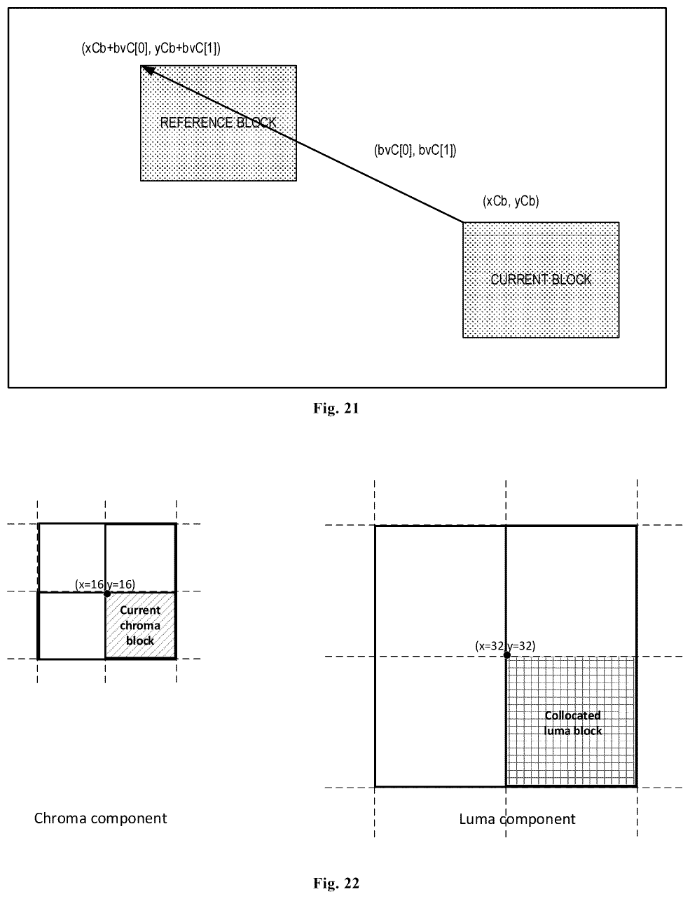

Then, by using the position of the current chroma block (xCb, yCb) and its bvC, the corresponding offset position (xCb+bvC[0], yCb+bvC[1]) is determined, and a block copying prediction is performed. FIG. 21 shows the prediction process of DBV mode.

A CU level flag is signaled to indicate whether the proposed DBV mode is applied as shown in Table 2.

TABLE 2
The binarization process for intra_{—}
chroma_pred_mode in the proposed method

| intra_chroma_{—} | bin | chroma intra |
|---|---|---|
| pred_mode | string | mode |
| 0 | 11100 | list[0] |
| 1 | 11101 | list[1] |
| 2 | 11110 | list[2] |
| 3 | 11111 | list[3] |
| 4 | 110 | DIMD chroma |
| 5 | 10 | DM |
| 6 | 0 | DBV |

### 3. Problems

There are several issues in the existing video coding techniques, which would be further improved for higher coding gain.
1. The DBV mode only consider block vectors from IBC coded luma blocks, which may not be optimal.
2. The intra luma coding (e.g., MPM list) may use neighbor block's IBC/intraTMP information.

### 4. Detailed Solutions

The detailed solutions below should be considered as examples to explain general concepts. These solutions should not be interpreted in a narrow way. Furthermore, these solutions can be combined in any manner.

The terms ‘video unit’ or ‘coding unit’ may represent a picture, a slice, a tile, a coding tree block (CTB), a coding tree unit (CTU), a coding block (CB), a CU, a PU, a TU, a PB, a TB.

The terms ‘block’ may represent a coding tree block (CTB), a coding tree unit (CTU), a coding block (CB), a CU, a PU, a TU, a PB, a TB.

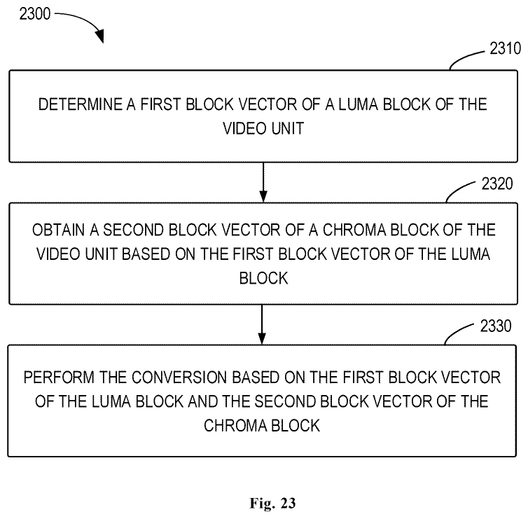

The terms ‘block vector’ may refer to a displacement/shift between a first block located at (x0, y0) and a second block located at (x1, y1). For example, it could be a motion vector of a block. For another example, it could be a block vector of a block. FIG. 22 shows an example of collocated luma block of the current chroma block in 4:2:0 color format.

TABLE 3
SubWidthC and SubHeightC values derived from chroma_format

| Chroma format | Sub WidthC | SubHeightC |
|---|---|---|
| Monochrome | 1 | 1 |
| 4:2:0 | 2 | 2 |
| 4:2:2 | 2 | 1 |
| 4:4:4 | 1 | 1 |

In the following discussion, the position of “collocated luma block” can be deduced from the position of the current chroma block, according to subsampling ratio (e.g., SubWidthC and SubHeightC as specified in Table 3) of the chroma format sampling structure. To be more specific, suppose the top-left sample of a chroma block is at position (xTbC, yTbC), then the top-left sample of the collocated luma block location (xTbY, yTbY) is derived as follows: (xTbY, yTbY)=(xTbC*SubWidthC, yTbC*SubHeightC). As illustrated in FIG. 22, for 4:2:0 color format, the top-left sample of the current chroma block is located at (x=16,y=16) in the chroma picture, then the top-left sample of its collocated luma block is located at (x=32,y=32) in the luma picture.

It is noted that the terminologies mentioned below are not limited to the specific ones defined in existing standards. Any variance of the coding tool is also applicable.
4.1 About the intra/IBC chroma prediction (e.g., the first problem and related issues), the following methods are proposed:
a. The block vector (BV) of a certain luma block may be used for chroma block coding.
   a. In one example, whether to and/or how to use BV of a certain luma block for a chroma block may depend on whether dual tree structure is applied.
   b. For example, the certain luma block may be intraTMP coded.
   c. For example, the certain luma block may be IBC coded.
   d. For example, an intra chroma mode may be derived based on the intraTMP coded luma block.
   e. For example, the BV of the intraTMP coded luma block may be stored in a buffer, and such BV may be used for the subsequent chroma coding.
   f. For example, a scaled BV may be generated from the one coded luma block which has BV and used for chroma coding.
      i. In one example, the coded luma block may be intraTMP coded.
      ii. For example, the scaling factor may be computed based on the chroma subsampling ratio between luma and chroma.
      iii. For example, the scaling factor may depend on color format such as 4:2:0 or 4:4:4.
      iv. For example, a scaled BV may be calculated based on a scaling factor and/or an offset and/or a shift, e.g., scaledBV=(a*lumaBV+b)>>s, wherein a denotes a scaling factor, b denotes an offset, s denotes a shifting factor.
         1. For example, s may be a positive integer, or 0, or a negative integer.
   g. In one example, the certain luma mode may refer to the collocated luma block, and/or its spatial (adjacent/non-adjacent) neighboring blocks, and/or a luma block which has a different position rather than the collocated one.
   h. In one example, the certain luma block may be located in the reconstructed luma block in a region collocated with the current chroma CU.
      i. In one example, the size of the certain luma block may be M×N.
         1. In one example, the size of the certain luma block may be 4×4.
         2. In one example, the size of the certain luma block may be 8×8.
      ii. In one example, the certain luma block may be any MxN block.
      iii. In one example, the certain luma block may be some predefined MxN blocks.
      iv. In one example, the certain luma block may be located at a specific position in the region, such as the center.
b. In one example, multiple BVs derived from luma block(s) may be used for a chroma block.
   a. In one example, a message (e.g., syntax parameter/variable/index/flag) may be signaled to indicate which BV is applied.
   b. In one example, it is derived at the decoder, which BV is applied.
   c. In one example, multiple BVs may be derived from different luma block(s).
      i. In one example, luma blocks may be located at different positions in the region collocated with the current chroma CU.
c. It may be used in a newly signalled intra chroma mode (e.g., DBV mode).
   a. For example, if such newly signalled intra chroma mode is used, a chroma prediction block may be derived by directly copying a reference chroma block pointed by a scaled BV, wherein the scaled BV is subsampled from the BV of one coded luma block which has BV.
      i. In one example, the coded luma block may be intraTMP coded.
d. It may be used in an existing intra chroma mode (e.g., DM mode).
   a. For example, if such existing intra chroma mode is used and a certain luma block has BV, then (instead of using a default mode such as planar mode for chroma coding), a chroma prediction block may be derived by directly copying a reference chroma block pointed by a scaled BV, wherein the scaled BV is subsampled from the BV of the certain luma block.
      i. In one example, a certain luma block may be intraTMP coded.
      ii. In one example, a certain luma block may be IBC coded.
   b. For example, if such existing intra chroma mode is selected and a certain luma block is coded with IBC, then (instead of using a default mode such as DC mode for chroma coding), a chroma prediction block may be derived by directly copying a reference chroma block pointed by a scaled BV, wherein the scaled BV is subsampled from the BV of the IBC coded luma block.
e. It may be used in IBC chroma mode.
   a. For example, if such IBC chroma mode is used and a certain luma block has BV, a chroma prediction block may be derived by directly copying a reference chroma block pointed by a scaled BV, wherein the scaled BV is subsampled from the BV of the certain luma block.
      i. In one example, a certain luma block may be intraTMP coded.
   b. Alternatively, the BV of a certain luma block (e.g., IBC coded, or, intraTMP coded) may be used as a predictor for current chroma block coding.
f. It may be used in intraTMP chroma mode.
   a. For example, if such intraTMP chroma mode is used and a certain luma block has BV, a chroma prediction block may be derived by directly copying a reference chroma block pointed by a scaled BV, wherein the scaled BV is subsampled from the BV of the certain luma block.
      i. In one example, a certain luma block may be intraTMP coded.
g. Whether and how to check intraTMP coded luma block during current block's chroma coding may be conditioned on the availability of IBC coded luma blocks.
   a. For example, only if the luma block at a pre-defined position is not IBC coded, the BV of intraTMP coded luma block at such position may be used.
   b. For example, only if a first set of luma blocks are all not IBC coded, the BV of an intraTMP coded luma block in a second set may be checked.
      i. For example, the positions of the first set of luma blocks may be same as (or, different from) those of the second set.
      ii. For example, the checking order of the first set of luma blocks may be same as (or, different from) those of the second set.
h. Whether and how to check IBC coded luma during current block's chroma coding may be conditioned on the availability of intraTMP coded blocks.
   a. For example, only if the luma block at a pre-defined position is not intraTMP coded, the BV of IBC coded luma block at such position may be used.
   b. For example, only if a first set of luma blocks are all not intraTMP coded, the BV of an IBC coded luma block in a second set may be used.
      i. For example, the positions of the first set of luma blocks may be same as (or, different from) those of the second set.
      ii. For example, the checking order of the first set of luma blocks may be same as (or, different from) those of the second set.
i. For example, both intraTMP coded and IBC coded luma blocks may be checked, based on a pre-defined rule.
j. For example, the first available/valid BV of IntraTMP (and/or IBC) coded luma block may be used.
k. For example, more than one BV are selected by on a pre-defined rule, and all of them are put in a table/list.
   a. For example, which BV is used to the chroma block may be implicitly derived based on coding information (e.g., decoder derived method).
   b. For example, which BV is used to the chroma block may be explicitly signalling by a syntax element (e.g., an index).
l. For example, available/valid BVs may be sorted by a pre-defined rule (e.g., template-cost-based reordering).
   a. For example, the first ordered BV (e.g., with the minimum cost) may be directly used.
   b. For example, which BV is used may be signalled.
m. It may be enabled in camera captured content coding.
n. It may be enabled in for screen content coding.
o. It may be enabled in single tree coding.
p. It may be enabled in dual tree coding.
4.2 About the intra luma coding using neighboring's intraTMP/IBC Information (e.g., the 2^{nd} problem and related issues), the following methods are proposed:
a. The block vector of an intraTMP (and/or IBC, and/or Intra) coded neighboring block may be used for current intra block coding.
   a. For example, the current intra block is luma component.
   b. For example, the current intra block is chroma component.
   c. For example, when building the MPM list for the current block, if a neighbor is coded as intraTMP (or, IBC), the current intra block coding may be applied based on the BV associated with the neighbor block.
      i. For example, the BV associated with the neighbor block may be directly used to the current intra block coding.
   d. For example, an indicator (e.g., an index, or, a flag) may be inserted to a MPM list indicating whether a neighboring block (e.g., at a certain position) is coded as intraTMP (or, IBC) mode, and if it is, the current intra block coding may be applied based on the BV associated with the neighbor block.
   e. For example, the BV associated with the intraTMP (or, IBC) block may be mapped to a regular intra mode (e.g., with a certain angle) and then used to the current intra block coding.
   i. For example, the mapping process may be based on gradient, histogram of gradient, DIMD, TIMD, and etc.
4.3 Other improvements for screen content coding:
a. IBC may be allowed to be used as a hypothesis of MHP mode.
b. IntraTMP may be allowed to be used as a hypothesis of MHP mode.
c. Block level adaptive OBMC on/off may be used, according to a decoder derived method.
   a. For example, based on the gradient calculation of prediction samples before OBMC, the OBMC may be disabled/enabled (e.g., without signalling).
   b. For example, based on the histogram of gradients of prediction samples before OBMC, the OBMC may be disabled/enabled (e.g., without signalling).
   c. For example, it may be used for merge mode.
   d. For example, it may be used for AMVP mode.
   e. For example, it may be used for IBC mode.
   f. For example, it may be used for Inter mode.
   g. For example, it may be used for intraTMP mode.
4.4 Other improvements for intra prediction coding:
a. Whether to use a specific intra prediction mode (e.g. horizontal mode and/or vertical mode) may be derived based on gradients.
   a. For example, the gradients may be calculated from a template constructed from neighboring samples.
   b. For example, DIMD based method may be used to calculate the gradients.
   c. For example, if the histogram of gradients along with horizontal/vertical direction is largely dominant than other direction, then horizontal/vertical mode is used.
      i. For example, in such case, the intra prediction may be not fusion with other modes.
      ii. For example, in such case, no need to signal whether to use horizontal mode or vertical mode.
      iii. For example, a new intra mode may be signalled for such mode.
         1. For example, a syntax flag may be signalled.
         2. For example, a syntax parameter (e.g., mode index) may be signalled.
   d. For example, it may be used for luma component.
   e. For example, it may be used for chroma component.
4.5 Whether to and/or how to apply the disclosed methods above may be signalled at sequence level/group of pictures level/picture level/slice level/tile group level, such as in sequence header/picture header/SPS/VPS/DPS/DCI/PPS/APS/slice header/tile group header.
4.6 Whether to and/or how to apply the disclosed methods above may be signalled at PB/TB/CB/PU/TU/CU/VPDU/CTU/CTU row/slice/tile/sub-picture/other kinds of region contain more than one sample or pixel.
4.7 Whether to and/or how to apply the disclosed methods above may be dependent on coded information, such as block size, colour format, single/dual tree partitioning, colour component, slice/picture type.

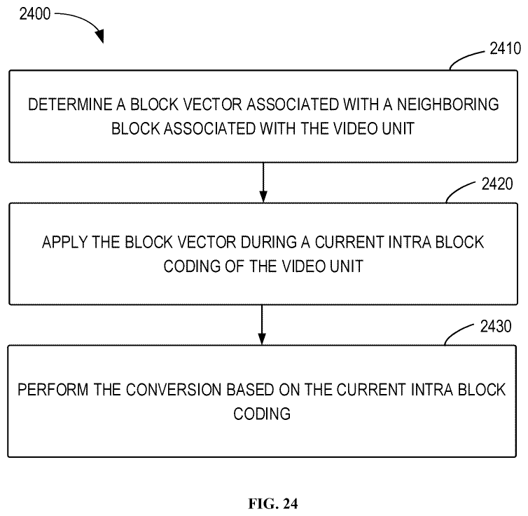

FIG. 23 illustrates a flowchart of a method 2300 for video processing in accordance with embodiments of the present disclosure. The method 2300 is implemented during a conversion between a target video block of a video and a bitstream of the video.

At block 2310, for a conversion between a video unit of a video and a bitstream of the video, a first block vector of a luma block of the video unit is determine. The luma block being coded with a target (i.e., a specific) coding mode.

At block 2320, a second block vector of a chroma block of the video unit is obtained based on the first block vector of the luma block.

At block 2330, the conversion is performed based on the first block vector of the luma block and the second block vector of the chroma block. In some embodiments, the conversion may include encoding the video unit into the bitstream. Alternatively, the conversion may include decoding the video unit from the bitstream. In this way, DBV mode is improved. Further, the coding efficiency has also be improved.

In some embodiments, the target coding mode is an intra template matching (IntraTMP) mode, and the luma block is a IntraTMP coded luma block. In some embodiments, the target coding mode is an intra block copy (IBC) mode, and the luma block is an IBC coded luma block. In some embodiments, an intra chroma mode is derived based on the luma block which is an intraTMP coded luma block. In some embodiments, the first block vector of the luma block which is an intraTMP coded luma block is stored in a buffer, and the first block vector is used for a subsequent chroma coding.

In some embodiments, a scaled block vector is generated from the luma block which has the first block vector and used for chroma coding. In some embodiments, a scaling factor is computed based on a chroma subsampling ratio between luma and chroma components. In some embodiments, the luma block is intraTMP coded. In some embodiments, a scaling factor depends on color format, and where the color format is one of: 4:2:0 or 4:4:4.

In some embodiments, the scaled block vector is computed based on at least one of: a scaling factor, an offset, or a shift. For example, the scaled block vector is computed by: scaledBV=(a*lumaBV+b)>>s, where scaledBV represents the scaled block vector, a represents the scaling factor, b represents the offset, s represents the shifting factor, lumaBV represents the first block vector of the luma block. In some embodiments, the shifting factor is one of: a positive integer, 0, or a negative integer.

In some embodiments, whether to and/or how to use the first block vector of the luma block for the chroma block depends on whether dual tree structure is applied. In some embodiments, the luma block comprises at least one of: a collocated luma block, a spatial (adjacent and/or non-adjacent) neighboring luma block of the collocated luma block, or a luma block which has a different position rather than the collocated luma block.

In some embodiments, the luma block is located in a reconstructed luma block in a region collocated with a current chroma coding unit. In some embodiments, a size of the luma block is M×N, where M and N are integers. In some embodiments, the size of the luma block is 4×4. Alternatively, the size of the luma block is 8×8.

In some embodiments, the luma block is one of luma blocks with a size of M×N, where M and N are integers. In some embodiments, the luma block is from a set of predefined luma blocks with a size of M×N, where M and N are integers.

In some embodiments, the luma block is located at a position in a region. In some embodiments, the luma block is located at a center of the region.

In some embodiments, obtaining the second block vector based on the first block vector is used in an intra chroma mode. In some embodiments, the intra chroma mode is a direction block vector (DBV) mode for chroma prediction. For example, it may be used in a newly signalled intra chroma mode (e.g., DBV mode).

In some embodiments, if the intra chroma mode is used, a chroma prediction block is derived by directly copying a reference chroma block pointed by a scaled block vector, where the scaled block vector is subsampled from the first block vector of the luma block. In some embodiments, the luma block is intraTMP coded.

In some embodiments, obtaining the second block vector based on the first block vector is used in an IBC chroma mode. In some embodiments, if the IBC chroma mode is used and the luma block has the first block vector, a chroma prediction block is derived by directly copying a reference chroma block pointed by a scaled block vector, where the scaled block vector is subsampled from the first block vector of the luma block. In some embodiments, the first block vector of the luma block is used as a predictor for current chroma block coding. In some embodiments, the luma block is intraTMP coded or IBC coded.

In some embodiments, obtaining the second block vector based on the first block vector is used in an intraTMP chroma mode. In some embodiments, if the intraTMP chroma mode is used and the luma block has the first block vector, a chroma prediction block is derived by directly copying a reference chroma block pointed by a scaled block vector, wherein the scaled block vector is subsampled from the first block vector of the luma block. In some embodiments, the luma block is intraTMP coded.

In some embodiments, whether and/or how to check an intraTMP coded luma block during a chroma coding of the chroma block is dependent on an availability of an IBC coded luma block. For example, only if the luma block at a pre-defined position is not IBC coded, a block vector of the of intraTMP coded luma block at the pre-defined position is used.

In some embodiments, only if a first set of luma blocks are all not IBC coded, a block vector of the intraTMP coded luma block in a second set of luma blocks is checked. In some embodiments, positions of the first set of luma blocks are same as those of the second set of luma blocks. Alternatively, the positions of the first set of luma blocks are different from those of the second set of luma blocks. In some embodiments, a checking order of the first set of luma blocks is same as that of the second set of luma blocks. Alternatively, the checking order of the first set of luma blocks is different from that of the second set of luma blocks.

In some embodiments, whether and/or how to check an IBC coded luma during a chroma coding of the chroma block is dependent on an availability of intraTMP coded blocks. In some embodiments, only if the luma block at a pre-defined position is not intraTMP coded, a block vector of the IBC coded luma block at the pre-defined position is used. In some embodiments, only if a first set of luma blocks are all not intraTMP coded, a block vector of the IBC coded luma block in a second set of luma blocks is checked.

In some embodiments, positions of the first set of luma blocks are same as those of the second set of luma blocks. Alternatively, the positions of the first set of luma blocks are different from those of the second set of luma blocks.

In some embodiments, a checking order of the first set of luma blocks is same as that of the second set of luma blocks. Alternatively, the checking order of the first set of luma blocks is different from that of the second set of luma blocks.

In some embodiments, both intraTMP coded and IBC coded luma blocks are checked based on a pre-defined rule. In some embodiments, a first available block vector of IntraTMP coded luma block is used. Alternatively, or in addition, a first available block vector of IBC coded luma block is used.

In some embodiments, a plurality of block vectors is selected based on a pre-defined rule, and wherein all of the plurality of block vectors are put in a table or list. In some embodiments, which block vector is used to the chroma block is implicitly derived based on coding information. For example, the coding information comprises a decoder derived method. In some embodiments, which block vector is used to the chroma block is explicitly indicated by a syntax element (for example, an index).

In some embodiments, available block vectors are sorted by a predefined rule. For example, the predefined rule comprises a template-cost-based reordering.

In some embodiments, a first ordered block vector (e.g., with the minimum cost) is directly used. In some embodiments, which block vector is used is indicated.

In some embodiments, obtaining the second block vector based on the first block vector is enabled in one of the followings: a camera captured content coding, a screen content coding, a single tree coding, or a dual tree coding.

In some embodiments, a plurality of block vectors derived from the luma block is used for the chroma block. In some embodiments, a message is signaled to indicate which block vector is applied. In some embodiments, the message comprises at least one of a syntax parameter, a variable, an index, or a flag.

In some embodiments, which block vector is derived at a decoder. In some embodiments, the plurality of block vectors is derived from different luma blocks. In some embodiments, luma blocks are located at different positions in a region collocated with a current chroma coding unit.

In some embodiments, obtaining the second block vector based on the first block vector is used in an existing intra chroma mode. In some embodiments, the existing intra chroma mode comprises a DM mode. In some embodiments, if the existing intra chroma mode is used and the luma block has the first block vector, a chroma prediction block is derived by directly copying a reference chroma block pointed by a scaled block vector, where the scaled block vector is subsampled from the first block vector of the luma block.

In some embodiments, the luma block is intraTMP coded. Alternatively, the luma block is IBC coded.

In some embodiments, if the existing intra chroma mode is selected and the luma block is coded with IBC, a chroma prediction block is derived by directly copying a reference chroma block pointed by a scaled block vector, where the scaled block vector is subsampled from the first block vector of the IBC coded luma block.

In some embodiments, an IBC is allowed to be used as a hypothesis of multiple hypothesis prediction (MHP) mode. Alternatively, or in addition, an intra TMP is allowed to be used as a MHP mode.

In some embodiments, a block level adaptive overlapped block motion compensation (OBMC) on/off is used according to a decoder derived method. In some embodiments, whether the OBMC is disabled or enabled is based on a gradient calculation of prediction samples before OBMC (for example, without signaling). In some embodiments, whether the OBMC is disabled or enabled is based on a histogram of gradients of prediction samples before OBMC (for example, without signaling). In some embodiments, the OBMC is used for at least one of: a merge mode, an advanced motion vector prediction (AMVP) mode, an IBC mode, an Inter mode, or an intraTMP mode.

In some embodiments, whether to use an intra prediction mode is derived based on gradients. In some embodiments, the gradients are computed from a template constructed from neighboring samples. In some embodiments, a DIMD based method is used to compute the gradients.

In some embodiments, if a histogram of the gradients along with horizontal direction or vertical direction is dominant than other direction, a horizontal mode or vertical mode is used. In some embodiments, the intra prediction mode is not fusion with other modes. In some embodiments, whether to use the horizontal mode or vertical mode is not indicated.

In some embodiments, a new intra mode is indicated for the horizontal mode or vertical mode. In some embodiments, a syntax flag is used to indicate the new intra mode, or a syntax parameter (for example, mode index) is used to indicate the new intra mode. In some embodiments, whether to use the intra prediction mode based on gradients is used for a luma component or a chroma component.

In some embodiments, an indication of whether to and/or how to obtain the second block vector based on the first block vector is indicated at one of the followings: a sequence level, a group of pictures level, a picture level, a slice level, or a tile group level.

In some embodiments, an indication of whether to and/or how to obtain the second block vector based on the first block vector is indicated in one of the following: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

In some embodiments, an indication of whether to and/or how to obtain the second block vector based on the first block vector is included in one of the following: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a sub-picture, or a region containing more than one sample or pixel.

In some embodiments, the method 2300 further comprises: determining, based on coded information of the video unit, whether to and/or how to obtain the second block vector based on the first block vector, the coded information including at least one of: a block size, a colour format, a single and/or dual tree partitioning, a colour component, a slice type, or a picture type.

According to further embodiments of the present disclosure, a non-transitory computer-readable recording medium is provided. The non-transitory computer-readable recording medium stores a bitstream of a video which is generated by a method performed by an apparatus for video processing. The method comprises: determining a first block vector of a luma block of a video unit of the video, the luma block being coded with a target coding mode; obtaining a second block vector of a chroma block of the video unit based on the first block vector of the luma block; and generating the bitstream based on the first block vector of the luma block and the second block vector of the chroma block.

According to still further embodiments of the present disclosure, a method for storing bitstream of a video is provided. The method comprises: determining a first block vector of a luma block of the video unit, the luma block being coded with a target coding mode; obtaining a second block vector of a chroma block of a video unit of the video based on the first block vector of the luma block; generating the bitstream based on the first block vector of the luma block and the second block vector of the chroma block; and storing the bitstream in a non-transitory computer-readable medium.

FIG. 24 illustrates a flowchart of a method 2400 for video processing in accordance with embodiments of the present disclosure. The method 2400 is implemented during a conversion between a target video block of a video and a bitstream of the video.

At block 2410, for a conversion between a video unit of a video and a bitstream of the video, a block vector associated with a neighboring block associated with the video unit is determined. The neighboring block is coded with a coding mode. In some embodiments, the neighboring block comprises at least one of: an intra template matching (intraTMP) coded neighboring block, an intra block copy (IBC) coded neighboring block, or an Intra coded neighboring block. In some embodiments, a current intra block of the video unit is one of: a luma component or a chroma component.

At block 2420, the block vector is applied during a current intra block coding of the video unit.

At block 2430, the conversion is performed based on the current intra block coding. In some embodiments, the conversion may include encoding the video unit into the bitstream. Alternatively, the conversion may include decoding the video unit from the bitstream. In this way, intra block coding is improved. Further, the coding efficiency has also be improved.

In some embodiments, when building a most probable mode (MPM) list for the video unit, if the neighboring block is coded as intraTMP or IBC, the current intra block coding is applied based on the block vector associated with the neighboring block. In some embodiments, the block vector associated with the neighboring block is directly used to the current intra block coding.

In some embodiments, an indicator (for example, an index or a flag) is inserted to a MPM list indicating whether the neighboring block (e.g., at a certain position) is coded with intraTMP or IBC mode. In some embodiments, if the indicator indicates that the neighboring block is coded with intraTMP or IBC mode, the current intra block coding is applied based on the block vector associated with the neighboring block.

In some embodiments, the block vector associate with the neighboring block which is intraTMP or IBC coded is mapped to a regular intra mode (e.g., with a certain angle) and the mapped block vector is used to the current block coding. In some embodiments, a mapping process is based on at least one of: a gradient, a histogram of gradient, a decoder side intra mode derivation (DIMD), or a template-based intra mode derivation (TIMD).

In some embodiments, an indication of whether to and/or how to apply the block vector during the current intra block coding of the video unit is indicated at one of the followings: a sequence level, a group of pictures level, a picture level, a slice level, or a tile group level.

In some embodiments, an indication of whether to and/or how to apply the block vector during the current intra block coding of the video unit is indicated in one of the following: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

In some embodiments, an indication of whether to and/or how to apply the block vector during the current intra block coding of the video unit is included in one of the following: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a sub-picture, or a region containing more than one sample or pixel.

In some embodiments, the method 2400 further comprises: determining, based on coded information of the video unit, whether to and/or how to apply the block vector during the current intra block coding of the video unit, the coded information including at least one of: a block size, a colour format, a single and/or dual tree partitioning, a colour component, a slice type, or a picture type.

In some embodiments, an IBC is allowed to be used as a hypothesis of multiple hypothesis prediction (MHP) mode. Alternatively, or in addition, an intra TMP is allowed to be used as a MHP mode.

In some embodiments, a block level adaptive overlapped block motion compensation (OBMC) on/off is used according to a decoder derived method. In some embodiments, whether the OBMC is disabled or enabled is based on a gradient calculation of prediction samples before OBMC (for example, without signaling). In some embodiments, whether the OBMC is disabled or enabled is based on a histogram of gradients of prediction samples before OBMC (for example, without signaling). In some embodiments, the OBMC is used for at least one of: a merge mode, an advanced motion vector prediction (AMVP) mode, an IBC mode, an Inter mode, or an intraTMP mode.

In some embodiments, whether to use an intra prediction mode is derived based on gradients. In some embodiments, the gradients are computed from a template constructed from neighboring samples. In some embodiments, a DIMD based method is used to compute the gradients.

In some embodiments, if a histogram of the gradients along with horizontal direction or vertical direction is dominant than other direction, a horizontal mode or vertical mode is used. In some embodiments, the intra prediction mode is not fusion with other modes. In some embodiments, whether to use the horizontal mode or vertical mode is not indicated.

In some embodiments, a new intra mode is indicated for the horizontal mode or vertical mode. In some embodiments, a syntax flag is used to indicate the new intra mode, or a syntax parameter (for example, mode index) is used to indicate the new intra mode. In some embodiments, whether to use the intra prediction mode based on gradients is used for a luma component or a chroma component.

According to further embodiments of the present disclosure, a non-transitory computer-readable recording medium is provided. The non-transitory computer-readable recording medium stores a bitstream of a video which is generated by a method performed by an apparatus for video processing. The method comprises: determining a block vector associated with a neighboring block associated with a video unit of the video, wherein the neighboring block is coded with a coding mode; applying the block vector during a current intra block coding of the video unit; and generating the bitstream based on the current intra block coding.

According to still further embodiments of the present disclosure, a method for storing bitstream of a video is provided. The method comprisesdetermining a block vector associated with a neighboring block associated with a video unit of the video, wherein the neighboring block is coded with a coding mode; applying the block vector during a current intra block coding of the video unit; generating the bitstream based on the current intra block coding; and storing the bitstream in a non-transitory computer-readable medium.

Implementations of the present disclosure can be described in view of the following clauses, the features of which can be combined in any reasonable manner.

Clause 1. A method of video processing, comprising: determining, for a conversion between a video unit of a video and a bitstream of the video, a first block vector of a luma block of the video unit, the luma block being coded with a target coding mode; obtaining a second block vector of a chroma block of the video unit based on the first block vector of the luma block; and performing the conversion based on the first block vector of the luma block and the second block vector of the chroma block.

Clause 2. The method of clause 1, wherein the target coding mode is an intra template matching (IntraTMP) mode, and the luma block is a IntraTMP coded luma block.

Clause 3. The method of clause 1, wherein the target coding mode is an intra block copy (IBC) mode, and the luma block is an IBC coded luma block.

Clause 4. The method of clause 1, wherein an intra chroma mode is derived based on the luma block which is an intraTMP coded luma block.

Clause 5. The method of clause 1, wherein the first block vector of the luma block which is an intraTMP coded luma block is stored in a buffer, and the first block vector is used for a subsequent chroma coding.

Clause 6. The method of clause 1, wherein a scaled block vector is generated from the luma block which has the first block vector and used for chroma coding.

Clause 7. The method of clause 6, wherein a scaling factor is computed based on a chroma subsampling ratio between luma and chroma components.

Clause 8. The method of clause 6, wherein the luma block is intraTMP coded.

Clause 9. The method of clause 6, wherein a scaling factor depends on color format, and wherein the color format is one of: 4:2:0 or 4:4:4.

Clause 10. The method of clause 6, wherein the scaled block vector is computed based on at least one of: a scaling factor, an offset, or a shift.

Clause 11. The method of clause 10, wherein the scaled block vector is computed by: scaledBV=(a*lumaBV+b)>>s, wherein scaledBV represents the scaled block vector, a represents the scaling factor, b represents the offset, s represents the shifting factor, lumaBV represents the first block vector of the luma block.

Clause 12. The method of clause 10, wherein the shifting factor is one of: a positive integer, 0, or a negative integer.

Clause 13. The method of clause 1, wherein whether to and/or how to use the first block vector of the luma block for the chroma block depends on whether dual tree structure is applied.

Clause 14. The method of clause 1, wherein the luma block comprises at least one of: a collocated luma block, a spatial neighboring luma block of the collocated luma block, or a luma block which has a different position rather than the collocated luma block.

Clause 15. The method of clause 1, wherein the luma block is located in a reconstructed luma block in a region collocated with a current chroma coding unit.

Clause 16. The method of clause 15, wherein a size of the luma block is M×N, wherein M and N are integers.

Clause 17. The method of clause 16, wherein the size of the luma block is 4×4, or wherein the size of the luma block is 8×8.

Clause 18. The method of clause 15, wherein the luma block is one of luma blocks with a size of M×N, wherein M and N are integers.

Clause 19. The method of clause 15, wherein the luma block is from a set of predefined luma blocks with a size of M×N, wherein M and N are integers.

Clause 20. The method of clause 15, wherein the luma block is located at a position in a region.

Clause 21. The method of clause 20, wherein the luma block is located at a center of the region.

Clause 22. The method of clause 1, wherein obtaining the second block vector based on the first block vector is used in an intra chroma mode.

Clause 23. The method of clause 22, wherein the intra chroma mode is a direction block vector (DBV) mode for chroma prediction.

Clause 24. The method of clause 22, wherein if the intra chroma mode is used, a chroma prediction block is derived by directly copying a reference chroma block pointed by a scaled block vector, wherein the scaled block vector is subsampled from the first block vector of the luma block.

Clause 25. The method of clause 24, wherein the luma block is intraTMP coded.

Clause 26. The method of clause 1, wherein obtaining the second block vector based on the first block vector is used in an IBC chroma mode.

Clause 27. The method of clause 26, wherein if the IBC chroma mode is used and the luma block has the first block vector, a chroma prediction block is derived by directly copying a reference chroma block pointed by a scaled block vector, wherein the scaled block vector is subsampled from the first block vector of the luma block.

Clause 28. The method of clause 26, wherein the first block vector of the luma block is used as a predictor for current chroma block coding.

Clause 29. The method of clause 27 or 28, wherein the luma block is intraTMP coded or IBC coded.

Clause 30. The method of clause 1, wherein obtaining the second block vector based on the first block vector is used in an intraTMP chroma mode.

Clause 31. The method of clause 30, wherein if the intraTMP chroma mode is used and the luma block has the first block vector, a chroma prediction block is derived by directly copying a reference chroma block pointed by a scaled block vector, wherein the scaled block vector is subsampled from the first block vector of the luma block.

Clause 32. The method of clause 31, wherein the luma block is intraTMP coded.

Clause 33. The method of clause 1, wherein whether and/or how to check an intraTMP coded luma block during a chroma coding of the chroma block is dependent on an availability of an IBC coded luma block.

Clause 34. The method of clause 33, wherein only if the luma block at a pre-defined position is not IBC coded, a block vector of the of intraTMP coded luma block at the pre-defined position is used.

Clause 35. The method of clause 33, wherein only if a first set of luma blocks are all not IBC coded, a block vector of the intraTMP coded luma block in a second set of luma blocks is checked.

Clause 36. The method of clause 35, wherein positions of the first set of luma blocks are same as those of the second set of luma blocks, or wherein the positions of the first set of luma blocks are different from those of the second set of luma blocks.

Clause 37. The method of clause 35, wherein a checking order of the first set of luma blocks is same as that of the second set of luma blocks, or wherein the checking order of the first set of luma blocks is different from that of the second set of luma blocks.

Clause 38. The method of clause 1, wherein whether and/or how to check an IBC coded luma during a chroma coding of the chroma block is dependent on an availability of intraTMP coded blocks.

Clause 39. The method of clause 38, wherein only if the luma block at a pre-defined position is not intraTMP coded, a block vector of the IBC coded luma block at the pre-defined position is used.

Clause 40. The method of clause 38, wherein only if a first set of luma blocks are all not intraTMP coded, a block vector of the IBC coded luma block in a second set of luma blocks is checked.

Clause 41. The method of clause 40, wherein positions of the first set of luma blocks are same as those of the second set of luma blocks, or wherein the positions of the first set of luma blocks are different from those of the second set of luma blocks.

Clause 42. The method of clause 40, wherein a checking order of the first set of luma blocks is same as that of the second set of luma blocks, or wherein the checking order of the first set of luma blocks is different from that of the second set of luma blocks.

Clause 43. The method of clause 1, wherein both intraTMP coded and IBC coded luma blocks are checked based on a pre-defined rule.

Clause 44. The method of clause 1, wherein a first available block vector of IntraTMP coded luma block is used, and/or wherein a first available block vector of IBC coded luma block is used.

Clause 45. The method of clause 1, wherein a plurality of block vectors is selected based on a pre-defined rule, and wherein all of the plurality of block vectors are put in a table or list.

Clause 46. The method of clause 45, wherein which block vector is used to the chroma block is implicitly derived based on coding information.

Clause 47. The method of clause 46, wherein the coding information comprises a decoder derived method.

Clause 48. The method of clause 45, wherein which block vector is used to the chroma block is explicitly indicated by a syntax element.

Clause 49. The method of clause 1, wherein available block vectors are sorted by a predefined rule.

Clause 50. The method of clause 49, wherein the predefined rule comprises a template-cost-based reordering.

Clause 51. The method of clause 49, wherein a first ordered block vector is directly used.

Clause 52. The method of clause 49, wherein which block vector is used is indicated.

Clause 53. The method of clause 1, wherein obtaining the second block vector based on the first block vector is enabled in one of the followings: a camera captured content coding, a screen content coding, a single tree coding, or a dual tree coding.

Clause 54. The method of clause 1, wherein a plurality of block vectors derived from the luma block is used for the chroma block.

Clause 55. The method of clause 54, wherein a message is signaled to indicate which block vector is applied.

Clause 56. The method of clause 55, wherein the message comprises at least one of a syntax parameter, a variable, an index, or a flag.

Clause 57. The method of clause 54, wherein which block vector is derived at a decoder.

Clause 58. The method of clause 54, wherein the plurality of block vectors is derived from different luma blocks.

Clause 59. The method of clause 58, wherein luma blocks are located at different positions in a region collocated with a current chroma coding unit.

Clause 60. The method clause 1, wherein obtaining the second block vector based on the first block vector is used in an existing intra chroma mode.

Clause 61. The method of clause 60, wherein the existing intra chroma mode comprises a DM mode.

Clause 62. The method of clause 60, wherein if the existing intra chroma mode is used and the luma block has the first block vector, a chroma prediction block is derived by directly copying a reference chroma block pointed by a scaled block vector, wherein the scaled block vector is subsampled from the first block vector of the luma block.

Clause 63. The method of clause 62, wherein the luma block is intraTMP coded, or wherein the luma block is IBC coded.

Clause 64. The method of clause 60, wherein if the existing intra chroma mode is selected and the luma block is coded with IBC, a chroma prediction block is derived by directly copying a reference chroma block pointed by a scaled block vector, wherein the scaled block vector is subsampled from the first block vector of the IBC coded luma block.

Clause 65. The method of any of clauses 1-64, wherein an indication of whether to and/or how to obtain the second block vector based on the first block vector is indicated at one of the followings: a sequence level, a group of pictures level, a picture level, a slice level, or a tile group level.

Clause 66. The method of any of clauses 1-64, wherein an indication of whether to and/or how to obtain the second block vector based on the first block vector is indicated in one of the following: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

Clause 67. The method of any of clauses 1-64, wherein an indication of whether to and/or how to obtain the second block vector based on the first block vector is included in one of the following: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a sub-picture, or a region containing more than one sample or pixel.

Clause 68. The method of any of clauses 1-64, further comprising: determining, based on coded information of the video unit, whether to and/or how to obtain the second block vector based on the first block vector, the coded information including at least one of: a block size, a colour format, a single and/or dual tree partitioning, a colour component, a slice type, or a picture type.

Clause 69. A method of video processing, comprising: determining, for a conversion between a video unit of a video and a bitstream of the video, a block vector associated with a neighboring block associated with the video unit, wherein the neighboring block is coded with a coding mode; applying the block vector during a current intra block coding of the video unit; and performing the conversion based on the current intra block coding.

Clause 70. The method of clause 69, wherein the neighboring block comprises at least one of: an intra template matching (intraTMP) coded neighboring block, an intra block copy (IBC) coded neighboring block, or an Intra coded neighboring block.

Clause 71. The method of clause 69, wherein a current intra block of the video unit is one of: a luma component or a chroma component.

Clause 72. The method of clause 69, wherein when building a most probable mode (MPM) list for the video unit, if the neighboring block is coded as intraTMP or IBC, the current intra block coding is applied based on the block vector associated with the neighboring block.

Clause 73. The method of clause 72, wherein the block vector associated with the neighboring block is directly used to the current intra block coding.

Clause 74. The method of clause 69, wherein an indicator is inserted to a MPM list indicating whether the neighboring block is coded with intraTMP or IBC mode.

Clause 75. The method of clause 74, wherein if the indicator indicates that the neighboring block is coded with intraTMP or IBC mode, the current intra block coding is applied based on the block vector associated with the neighboring block.

Clause 76. The method of clause 69, wherein the block vector associate with the neighboring block which is intraTMP or IBC coded is mapped to a regular intra mode and the mapped block vector is used to the current block coding.

Clause 77. The method of clause 76, wherein a mapping process is based on at least one of: a gradient, a histogram of gradient, a decoder side intra mode derivation (DIMD), or a template-based intra mode derivation (TIMD).

Clause 78. The method of any of clauses 69-77, wherein an indication of whether to and/or how to apply the block vector during the current intra block coding of the video unit is indicated at one of the followings: a sequence level, a group of pictures level, a picture level, a slice level, or a tile group level.

Clause 79. The method of any of clauses 69-77, wherein an indication of whether to and/or how to apply the block vector during the current intra block coding of the video unit is indicated in one of the following: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

Clause 80. The method of any of clauses 69-77, wherein an indication of whether to and/or how to apply the block vector during the current intra block coding of the video unit is included in one of the following: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a sub-picture, or a region containing more than one sample or pixel.

Clause 81. The method of any of clauses 69-77, further comprising: determining, based on coded information of the video unit, whether to and/or how to apply the block vector during the current intra block coding of the video unit, the coded information including at least one of: a block size, a colour format, a single and/or dual tree partitioning, a colour component, a slice type, or a picture type.

Clause 82. The method of any of clauses 1-81, wherein an IBC is allowed to be used as a hypothesis of multiple hypothesis prediction (MHP) mode, and/or wherein an intra TMP is allowed to be used as a MHP mode.

Clause 83. The method of any of clauses 1-81, wherein a block level adaptive overlapped block motion compensation (OBMC) on/off is used according to a decoder derived method.

Clause 84. The method of clause 83, wherein whether the OBMC is disabled or enabled is based on a gradient calculation of prediction samples before OBMC.

Clause 85. The method of clause 83, wherein whether the OBMC is disabled or enabled is based on a histogram of gradients of prediction samples before OBMC.

Clause 86. The method of clause 83, wherein the OBMC is used for at least one of: a merge mode, an advanced motion vector prediction (AMVP) mode, an IBC mode, an Inter mode, or an intraTMP mode.

Clause 87. The method of any of clauses 1-86, wherein whether to use an intra prediction mode is derived based on gradients.

Clause 88. The method of clause 87, wherein the gradients are computed from a template constructed from neighboring samples.

Clause 89. The method of clause 87, wherein a DIMD based method is used to compute the gradients.

Clause 90. The method of clause 87, wherein if a histogram of the gradients along with horizontal direction or vertical direction is dominant than other direction, a horizontal mode or vertical mode is used.

Clause 91. The method of clause 90, wherein the intra prediction mode is not fusion with other modes.

Clause 92. The method of clause 90, wherein whether to use the horizontal mode or vertical mode is not indicated.

Clause 93. The method of clause 90, wherein a new intra mode is indicated for the horizontal mode or vertical mode.

Clause 94. The method of clause 93, wherein a syntax flag is used to indicate the new intra mode, or wherein a syntax parameter is used to indicate the new intra mode.

Clause 95. The method of clause 87, wherein whether to use the intra prediction mode based on gradients is used for a luma component or a chroma component.

Clause 96. The method of any of clauses 1-95, wherein the conversion includes encoding the video unit into the bitstream.

Clause 97. The method of any of clauses 1-95, wherein the conversion includes decoding the video unit from the bitstream.

Clause 98. An apparatus for video processing comprising a processor and a non-transitory memory with instructions thereon, wherein the instructions upon execution by the processor, cause the processor to perform a method in accordance with any of clauses 1-97.

Clause 99. A non-transitory computer-readable storage medium storing instructions that cause a processor to perform a method in accordance with any of clauses 1-97.

Clause 100. A non-transitory computer-readable recording medium storing a bitstream of a video which is generated by a method performed by an apparatus for video processing, wherein the method comprises: determining a first block vector of a luma block of a video unit of the video, the luma block being coded with a target coding mode; obtaining a second block vector of a chroma block of the video unit based on the first block vector of the luma block; and generating the bitstream based on the first block vector of the luma block and the second block vector of the chroma block.

Clause 101. A method for storing a bitstream of a video, comprising: determining a first block vector of a luma block of the video unit, the luma block being coded with a target coding mode; obtaining a second block vector of a chroma block of a video unit of the video based on the first block vector of the luma block; generating the bitstream based on the first block vector of the luma block and the second block vector of the chroma block; and storing the bitstream in a non-transitory computer-readable medium.

Clause 102. A non-transitory computer-readable recording medium storing a bitstream of a video which is generated by a method performed by an apparatus for video processing, wherein the method comprises: determining a block vector associated with a neighboring block associated with a video unit of the video, wherein the neighboring block is coded with a coding mode; applying the block vector during a current intra block coding of the video unit; and generating the bitstream based on the current intra block coding.

Clause 103. A method for storing a bitstream of a video, comprising: determining a block vector associated with a neighboring block associated with a video unit of the video, wherein the neighboring block is coded with a coding mode; applying the block vector during a current intra block coding of the video unit; generating the bitstream based on the current intra block coding; and storing the bitstream in a non-transitory computer-readable medium.

### Example Device

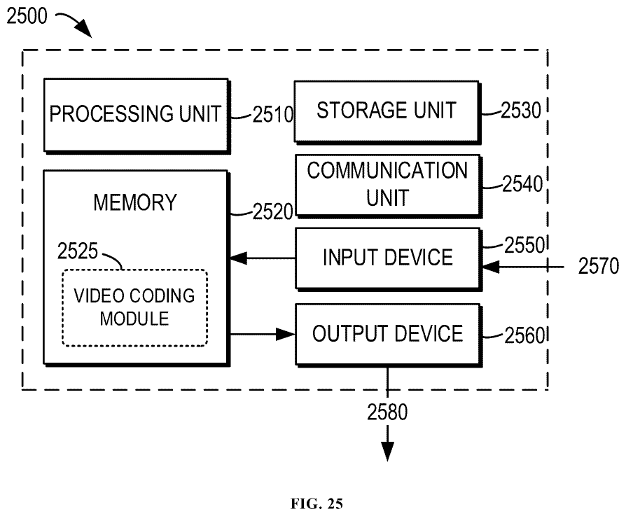

FIG. 25 illustrates a block diagram of a computing device 2500 in which various embodiments of the present disclosure can be implemented. The computing device 2500 may be implemented as or included in the source device 110 (or the video encoder 114 or 200) or the destination device 120 (or the video decoder 124 or 300).

It would be appreciated that the computing device 2500 shown in FIG. 25 is merely for purpose of illustration, without suggesting any limitation to the functions and scopes of the embodiments of the present disclosure in any manner.

As shown in FIG. 25, the computing device 2500 includes a general-purpose computing device 2500. The computing device 2500 may at least comprise one or more processors or processing units 2510, a memory 2520, a storage unit 2530, one or more communication units 2540, one or more input devices 2550, and one or more output devices 2560.

In some embodiments, the computing device 2500 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 2500 can support any type of interface to a user (such as “wearable” circuitry and the like).

The processing unit 2510 may be a physical or virtual processor and can implement various processes based on programs stored in the memory 2520. In a multi-processor system, multiple processing units execute computer executable instructions in parallel so as to improve the parallel processing capability of the computing device 2500. The processing unit 2510 may also be referred to as a central processing unit (CPU), a microprocessor, a controller or a microcontroller.

The computing device 2500 typically includes various computer storage medium. Such medium can be any medium accessible by the computing device 2500, including, but not limited to, volatile and non-volatile medium, or detachable and non-detachable medium. The memory 2520 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 2530 may be any detachable or non-detachable medium and may include a machine-readable medium such as a memory, flash memory drive, magnetic disk or another other media, which can be used for storing information and/or data and can be accessed in the computing device 2500.

The computing device 2500 may further include additional detachable/non-detachable, volatile/non-volatile memory medium. Although not shown in FIG. 25, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 2540 communicates with a further computing device via the communication medium. In addition, the functions of the components in the computing device 2500 can be implemented by a single computing cluster or multiple computing machines that can communicate via communication connections. Therefore, the computing device 2500 can operate in a networked environment using a logical connection with one or more other servers, networked personal computers (PCs) or further general network nodes.

The input device 2550 may be one or more of a variety of input devices, such as a mouse, keyboard, tracking ball, voice-input device, and the like. The output device 2560 may be one or more of a variety of output devices, such as a display, loudspeaker, printer, and the like. By means of the communication unit 2540, the computing device 2500 can further communicate with one or more external devices (not shown) such as the storage devices and display device, with one or more devices enabling the user to interact with the computing device 2500, or any devices (such as a network card, a modem and the like) enabling the computing device 2500 to communicate with one or more other computing devices, if required. Such communication can be performed via input/output (I/O) interfaces (not shown).

In some embodiments, instead of being integrated in a single device, some or all components of the computing device 2500 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 2500 may be used to implement video encoding/decoding in embodiments of the present disclosure. The memory 2520 may include one or more video coding modules 2525 having one or more program instructions. These modules are accessible and executable by the processing unit 2510 to perform the functionalities of the various embodiments described herein.

In the example embodiments of performing video encoding, the input device 2550 may receive video data as an input 2570 to be encoded. The video data may be processed, for example, by the video coding module 2525, to generate an encoded bitstream. The encoded bitstream may be provided via the output device 2560 as an output 2580.

In the example embodiments of performing video decoding, the input device 2550 may receive an encoded bitstream as the input 2570. The encoded bitstream may be processed, for example, by the video coding module 2525, to generate decoded video data. The decoded video data may be provided via the output device 2560 as the output 2580.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method of video processing, comprising:
determining, for a conversion between a video unit of a video and a bitstream of the video, a first block vector of a luma block of the video unit, the luma block being coded with a target coding mode;
obtaining a second block vector of a chroma block of the video unit based on the first block vector of the luma block; and
performing the conversion based on the first block vector of the luma block and the second block vector of the chroma block.

2. The method of claim 1, wherein the target coding mode is an intra template matching (IntraTMP) mode, and the luma block is a IntraTMP coded luma block, and/or
wherein the target coding mode is an intra block copy (IBC) mode, and the luma block is an IBC coded luma block, and/or
wherein an intra chroma mode is derived based on the luma block which is an intraTMP coded luma block, and/or
wherein the first block vector of the luma block which is an intraTMP coded luma block is stored in a buffer, and the first block vector is used for a subsequent chroma coding, and/or
wherein a scaled block vector is generated from the luma block which has the first block vector and used for chroma coding, and/or
wherein the luma block comprises at least one of: a collocated luma block, a spatial neighboring luma block of the collocated luma block, or a luma block which has a different position rather than the collocated luma block, and/or
wherein the luma block is located in a reconstructed luma block in a region collocated with a current chroma coding unit, and/or
wherein a plurality of block vectors is selected based on a pre-defined rule, and all of the plurality of block vectors are put in a table or list, and/or
wherein a plurality of block vectors derived from the luma block is used for the chroma block.

3. The method of claim 2, wherein a scaling factor is computed based on a chroma subsampling ratio between luma and chroma components, and/or
wherein a scaling factor depends on color format, and the color format is one of: 4:2:0 or 4:4:4, and/or
wherein the scaled block vector is computed based on at least one of: a scaling factor, an offset, or a shift, and/or
wherein a size of the luma block is M×N, wherein M and N are integers, and/or
wherein the luma block is one of luma blocks with a size of M×N, wherein M and N are integers, and/or
wherein the luma block is from a set of predefined luma blocks with a size of M×N, wherein M and N are integers, and/or
wherein the luma block is located at a position in a region, and/or
wherein the luma block is located at a center of the region, and/or
wherein which block vector is used to the chroma block is implicitly derived based on coding information, and/or
wherein a message is signaled to indicate which block vector is applied, and/or
wherein which block vector is derived at a decoder, and/or
wherein the plurality of block vectors is derived from different luma blocks.

4. The method of claim 3, wherein the scaled block vector is computed by: scaledBV+(a*lumaBV+b)>>s, wherein scaledBV represents the scaled block vector, a represents the scaling factor, b represents the offset, s represents the shifting factor, lumaBV represents the first block vector of the luma block, and/or
wherein the shifting factor is one of: a positive integer, 0, or a negative integer, and/or
wherein the size of the luma block is 4×4, or the size of the luma block is 8×8, and/or
wherein the coding information comprises a decoder derived method, and/or
wherein the message comprises at least one of a syntax parameter, a variable, an index, or a flag, and/or
wherein luma blocks are located at different positions in a region collocated with a current chroma coding unit.

5. The method of claim 1, wherein obtaining the second block vector based on the first block vector is used in an intra chroma mode, and/or
wherein obtaining the second block vector based on the first block vector is used in an IBC chroma mode, and/or
wherein obtaining the second block vector based on the first block vector is used in an intraTMP chroma mode.

6. The method of claim 5, wherein the intra chroma mode is a direction block vector (DBV) mode for chroma prediction, and/or
wherein if the intra chroma mode is used, a chroma prediction block is derived by directly copying a reference chroma block pointed by a scaled block vector, wherein the scaled block vector is subsampled from the first block vector of the luma block, and/or
wherein if the IBC chroma mode is used and the luma block has the first block vector, a chroma prediction block is derived by directly copying a reference chroma block pointed by a scaled block vector, wherein the scaled block vector is subsampled from the first block vector of the luma block, and/or
wherein the first block vector of the luma block is used as a predictor for current chroma block coding, and/or
wherein if the intraTMP chroma mode is used and the luma block has the first block vector, a chroma prediction block is derived by directly copying a reference chroma block pointed by a scaled block vector, wherein the scaled block vector is subsampled from the first block vector of the luma block.

7. The method of claim 6, wherein the luma block is intraTMP coded or IBC coded.

8. The method of claim 1, wherein whether and/or how to check an intraTMP coded luma block during a chroma coding of the chroma block is dependent on an availability of an IBC coded luma block, and/or
wherein whether and/or how to check an IBC coded luma during a chroma coding of the chroma block is dependent on an availability of intraTMP coded blocks, and/or
wherein both intraTMP coded and IBC coded luma blocks are checked based on a pre-defined rule, and/or
wherein a first available block vector of IntraTMP coded luma block is used, and/or
wherein a first available block vector of IBC coded luma block is used, and/or
wherein available block vectors are sorted by a predefined rule, and/or
wherein obtaining the second block vector based on the first block vector is enabled in one of the followings: a camera captured content coding, a screen content coding, a single tree coding, or a dual tree coding.

9. The method of claim 8, wherein only if the luma block at a pre-defined position is not IBC coded, a block vector of the of intraTMP coded luma block at the pre-defined position is used, and/or
wherein only if the luma block at a pre-defined position is not intraTMP coded, a block vector of the IBC coded luma block at the pre-defined position is used, and/or
wherein the predefined rule comprises a template-cost-based reordering, and/or
wherein a first ordered block vector is directly used.

10. The method of claim 1, wherein a block vector associated with a neighboring block associated with the video unit is determined, the neighboring block is coded with a coding mode, and the block vector is applied during a current intra block coding of the video unit.

11. The method of claim 10, wherein the neighboring block comprises at least one of: an intra template matching (intraTMP) coded neighboring block, an intra block copy (IBC) coded neighboring block, or an Intra coded neighboring block, and/or
wherein a current intra block of the video unit is one of: a luma component or a chroma component, and/or
wherein when building a most probable mode (MPM) list for the video unit, if the neighboring block is coded as intraTMP or IBC, the current intra block coding is applied based on the block vector associated with the neighboring block, and/or
wherein the block vector associate with the neighboring block which is intraTMP or IBC coded is mapped to a regular intra mode and the mapped block vector is used to the current block coding.

12. The method of claim 11, wherein the block vector associated with the neighboring block is directly used to the current intra block coding, and/or
wherein a mapping process is based on at least one of: a gradient, a histogram of gradient, a decoder side intra mode derivation (DIMD), or a template-based intra mode derivation (TIMD).

13. The method of claim 1, wherein a block level adaptive overlapped block motion compensation (OBMC) on/off is used according to a decoder derived method, and/or
wherein whether to use an intra prediction mode is derived based on gradients.

14. The method of claim 13, wherein whether the OBMC is disabled or enabled is based on a gradient calculation of prediction samples before OBMC, and/or
wherein whether the OBMC is disabled or enabled is based on a histogram of gradients of prediction samples before OBMC, and/or
wherein the OBMC is used for at least one of: a merge mode, an advanced motion vector prediction (AMVP) mode, an IBC mode, an Inter mode, or an intraTMP mode, and/or
wherein the gradients are computed from a template constructed from neighboring samples, and/or
wherein a DIMD based method is used to compute the gradients, and/or
wherein if a histogram of the gradients along with horizontal direction or vertical direction is dominant than other direction, a horizontal mode or vertical mode is used, and/or whether to use the intra prediction mode based on gradients is used for a luma component or a chroma component.

15. The method of claim 14, wherein the intra prediction mode is not fusion with other modes, and/or
wherein whether to use the horizontal mode or vertical mode is not indicated, and/or
wherein a new intra mode is indicated for the horizontal mode or vertical mode.

16. The method of claim 15, wherein a syntax flag is used to indicate the new intra mode, or
wherein a syntax parameter is used to indicate the new intra mode.

17. The method of claim 1, wherein the conversion includes encoding the video unit into the bitstream, or
wherein the conversion includes decoding the video unit from the bitstream.

18. An apparatus for video processing comprising a processor and a non-transitory memory with instructions thereon, wherein the instructions upon execution by the processor, cause the processor to:
determine, for a conversion between a video unit of a video and a bitstream of the video, a first block vector of a luma block of the video unit, the luma block being coded with a target coding mode;
obtain a second block vector of a chroma block of the video unit based on the first block vector of the luma block; and
perform the conversion based on the first block vector of the luma block and the second block vector of the chroma block.

19. A non-transitory computer-readable storage medium storing instructions that cause a processor to:
determine, for a conversion between a video unit of a video and a bitstream of the video, a first block vector of a luma block of the video unit, the luma block being coded with a target coding mode;
obtain a second block vector of a chroma block of the video unit based on the first block vector of the luma block; and
perform the conversion based on the first block vector of the luma block and the second block vector of the chroma block.

20. A non-transitory computer-readable recording medium storing a bitstream of a video which is generated by a method performed by an apparatus for video processing, wherein the method comprises:
determining a first block vector of a luma block of a video unit of the video, the luma block being coded with a target coding mode;
obtaining a second block vector of a chroma block of the video unit based on the first block vector of the luma block; and
generating the bitstream based on the first block vector of the luma block and the second block vector of the chroma block.
